(19) United States
(12) Patent Application Publication
(10) Pub. No.: US 2015/0363976 A1
(43) Pub. Date: Dec. 17, 2015

(54) Generating a Sequence of Stereoscopic Images for a Head-Mounted Display

(71) Applicant: Next Logic Pty Ltd., North Turramurra (AU)

(72) Inventor: Michael Anthony Henson, Vancouver (CA)

(21) Appl. No.: 14/731,611

(22) Filed: Jun. 5, 2015

(30) Foreign Application Priority Data
Jun. 17, 2014 (GB) 1410744.5

(51) Int. Cl. G06T 19/00; G06T 7/20; H04N 13/00; H04N 13/04; G06T 15/04; G06T 17/05

(52) U.S. Cl. CPC G06T 19/006; G06T 19/003; G06T 15/04; G06T 17/05; H04N 13/0014; H04N 13/0059; H04N 13/0429; H04N 13/045; G06T 7/208; G06T 2200/04; G06T 2207/10004; G06T 2207/10028; G06T 2210/61; G06T 2219/016; H04N 2013/0085; H04N 2013/0081; H04N 2213/005; H04N 2213/008

(57) ABSTRACT

Apparatus (301) for generating a sequence of stereoscopic images for a head-mounted display depicting a virtual environment includes an angular motion sensor (402) that outputs an indication of the orientation of the head-mounted display, a texture buffer (409) that is refreshed with left and right textures that define left and a right pre-rendered scenes in the virtual environment, a rendering processor (412) which then renders left and right images from respective render viewpoints determined by the output of the angular motion sensor, by mapping the textures onto respectively left and right spheres or polyhedrons, the left and right rendered images then being provided to a stereoscopic display (202, 203) in the head-mounted display, and the rendering processor renders the left and right images at a higher rate than the left and right textures are refreshed in the texture buffer.

### CROSS REFERENCE TO RELATED APPLICATIONS

This application represents the first application for a patent directed towards the invention and the subject matter.

### BACKGROUND OF THE INVENTION

1. Field of the Invention

The present invention relates to the generation of a sequence of stereoscopic images for a head-mounted display, which depict a virtual environment.

2. Description of the Related Art

Immersive virtual reality delivered by way of head-mounted displays is steadily becoming a more realistic possibility with progress in display technology, sensing devices, processing power and application development. A fully immersive experience, however, is not at present possible due to several factors, such as the latency in response to head movement, the requirement for a very wide field of view, the resolution of the displays used, and the frame rate of the virtual scene displayed to a wearer of a head-mounted display.

State-of-the-art approaches to providing an immersive experience centre on the use of stereoscopic display drivers for graphics cards, where the display device is a stereoscopic head-mounted display. A virtual environment may be rendered in real time and supplied to the headset, with the camera position and orientation in the virtual environment being related to the output of sensors in the headset.

A problem with this approach is that, in order to maintain a reasonable frame rate of 60 frames per second, the stereoscopic imagery must be generated at a rate of 60 hertz. A sacrifice must therefore be made in terms of the quality of the rendered images such that the frame rate does not drop. This has a detrimental impact on how immersive the experience is due to necessary reductions in scene complexity to meet the rendering deadline for each frame.

A further problem exists in that, whilst 60 frames per second tends to be an acceptable frame rate for display on static monitors, the ability of the eyes to move very quickly relative to close and static pixels, which is the case in a head-mounted display, results in a judder effect which can contribute greatly to feelings of nausea. The judder effect most markedly manifests itself during the display of an object which is static in a scene during a head rotation, but with the eyes remaining on said object. As the fixed pixels in the display are illuminated for a fixed period of time (typically commensurate with the refresh rate), the viewer may experience smear, in which their head is moving smoothly whilst the discrete pixels are on. This is then followed by a jump as the display is refreshed, which causes strobing, and the object is displaced by a number of pixels opposite to the direction of motion.

A solution employed by state-of-the-art headsets is to use low persistence displays which reduces the judder effect during eye movement as smear is reduced. However, due to these displays still only refreshing at standard rates such as 60 hertz, it still does not solve the general problem of the image refresh rate causing the strobing effect in the human visual system.

Thus a solution is required which ensures that a realistic appearance of the virtual environment is maintained or even enhanced, and which also allows an increase in the frame rate to combat any nausea.

### BRIEF SUMMARY OF THE INVENTION

According to an aspect of the present invention, there is provided apparatus for generating a sequence of stereoscopic images for a head-mounted display depicting a virtual environment, comprising: an angular motion sensor configured to provide an output indicative of the orientation of the apparatus; a texture buffer that is refreshed with a left and a right texture respectively defining a left and a right pre-rendered version of one of a plurality of possible scenes in said virtual environment; a rendering processor configured to render left and right images from respective render viewpoints, including a process of mapping the left texture onto a left sphere or polyhedron, and mapping the right texture onto a right sphere or polyhedron, and wherein the direction of the render viewpoints is determined by the output of the angular motion sensor; and a display interface for outputting the left and right images to a stereoscopic display; wherein the rendering processor renders the left and right images at a higher rate than the left and right textures are refreshed in the texture buffer.

According to another aspect of the present invention, there is provided a method of generating a sequence of stereoscopic imagery for a head-mounted display, the imagery depicting progression along a path through a virtual environment when moving along said path in a real environment, comprising the steps of: at a first refresh rate, loading into memory a left texture and a right texture defining respective pre-rendered versions of a scene in said virtual environment, the textures corresponding to a predicted position of the head-mounted display on said path; at a second refresh rate, displaying rendering left and right images rendered from respective render viewpoints, in which the left and right textures in memory are mapped onto respective spheres or polyhedrons, and wherein the render viewpoints are based on a predicted orientation of the head-mounted display; and at the second refresh rate, displaying the left and right images in a head-mounted display; wherein the first refresh rate is lower than the second refresh rate.

According to a further aspect of the present invention, there is provided a head-mounted display for displaying a sequence of stereoscopic imagery depicting progression along a path through a virtual environment when moving along said path in a real environment, comprising: a linear motion sensor configured to provide an output indicative of the position of the apparatus; a data interface configured to retrieve, from a remote texture storage or generation device, a left and a right texture respectively defining a left and a right pre-rendered version of a scene in said virtual environment corresponding to the position of the head-mounted display; a texture buffer configured to store the left and right textures; an angular motion sensor configured to provide an output indicative of the orientation of the head-mounted display; a rendering processor configured to render left and right images from respective render viewpoints, including a process of mapping the left texture onto a left sphere or polyhedron, and mapping the right texture onto a right sphere or polyhedron, and wherein the direction of the render viewpoints is determined by the orientation of the head-mounted display; and a stereoscopic display configured to display the left and right images; wherein the rendering processor renders the left and right images at a higher rate than the left and right textures are refreshed in the texture buffer.

### BRIEF DESCRIPTION OF THE DRAWINGS

FIG. 1 shows a proposed environment in which the present invention may be deployed;

FIG. 2 shows communication between head-mounted display 101, which is travelling along the path 105, and storage location 106;

FIG. 3 shows the hardware components within the head-mounted display 101;

FIG. 4 shows a block diagram detailing the functional components within image generation device 301;

FIG. 5 shows a high level overview of processes undertaken in the generation of stereoscopic imagery by image generation device 301;

FIG. 6 shows an example of the motion data produced by motion sensors 302;

FIG. 7 shows the segregation of processing by refresh rate;

FIG. 8 shows the process employed by the present invention to select textures from texture server 206;

FIG. 9 shows the procedure used for predicting position;

FIG. 10 shows the position estimation process 1000 used by position estimation processor 404;

FIG. 11 shows the texture fetching process 1100 used by texture fetching processor 406;

FIG. 12 shows the changes to the orientation of the head-mounted display 101 over a time period 2t;

FIG. 13 shows the prediction process 1300;

FIG. 14 shows the orientation estimation process 1400 used by orientation estimation processor 405;

FIG. 15 shows the viewpoint control process 1500 used by viewpoint controller 410;

FIG. 16 shows the rendering process 1600 used by rendering processor 412 to generate one of the left or right images for output;

FIG. 17 shows the texture mapping process of step 1602;

FIG. 18 shows the procedure carried out during texture mapping step 1602;

FIG. 19 shows a first embodiment of texture server 206, in which it is configured as a texture storage device 1901;

FIG. 20 shows two alternative ways in which textures can be read from storage;

FIG. 21 details the texture request process 1103A;

FIG. 22 shows the texture retrieval process 2200 executed by CPU 1904;

FIG. 23 shows a second embodiment of texture server 206, in which it is arranged as a texture generation device 2301; and

FIG. 24 shows two alternative ways in which textures can be generated;

FIG. 25 details the texture request process 1103B;

FIG. 26 shows the texture generation process 2600 executed by CPU 2304.

### DETAILED DESCRIPTION OF EXAMPLE EMBODIMENTS

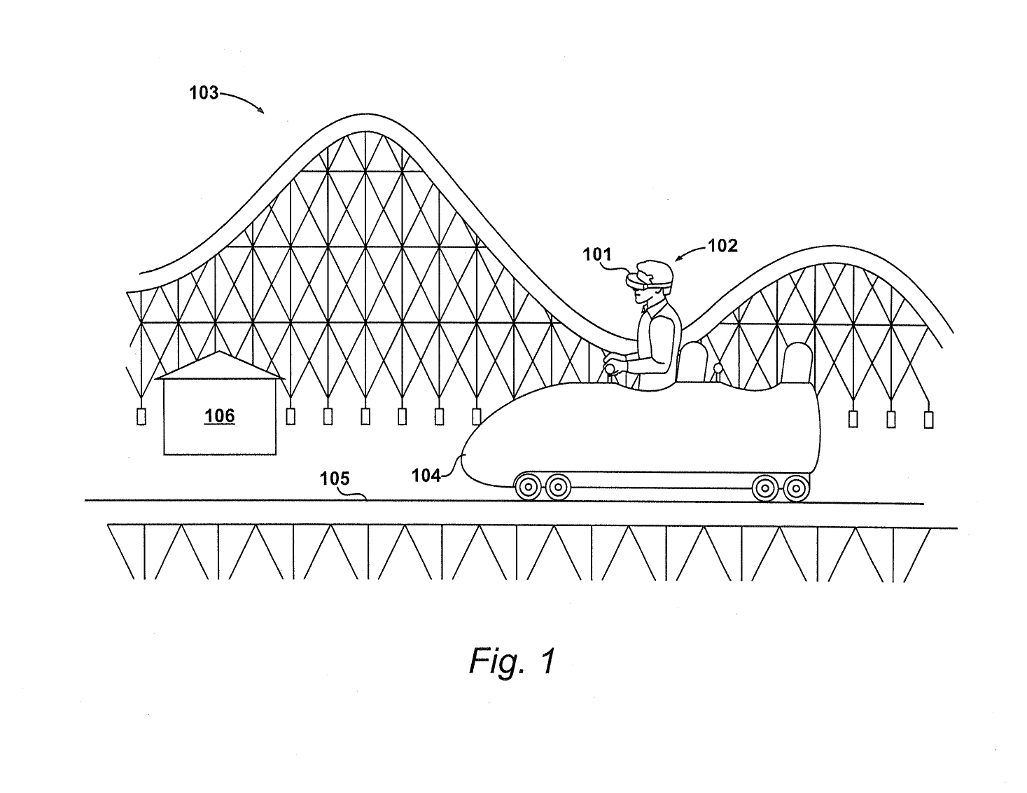

### FIG. 1

A proposed environment in which the present invention may be deployed is shown in FIG. 1, in which a head-mounted display 101 is being worn by a passenger 102 on an amusement ride at a theme park, which in this example is a roller coaster 103. The cart 104 of the roller coaster 103 moves along a path 105 in this real environment, which is in this case the track of the roller coaster 103.

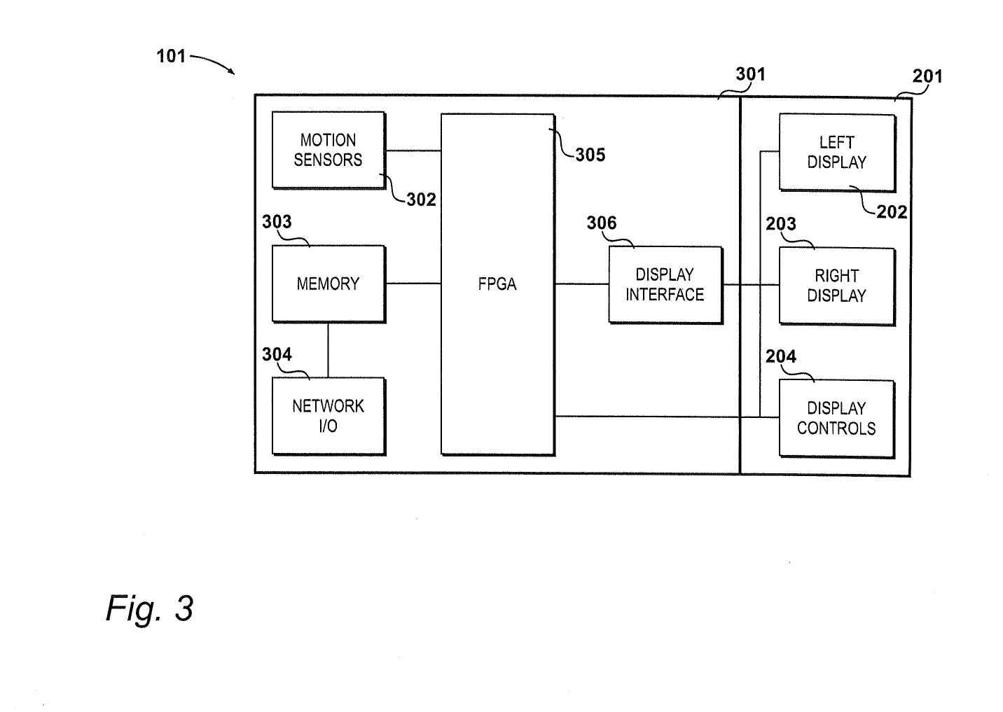

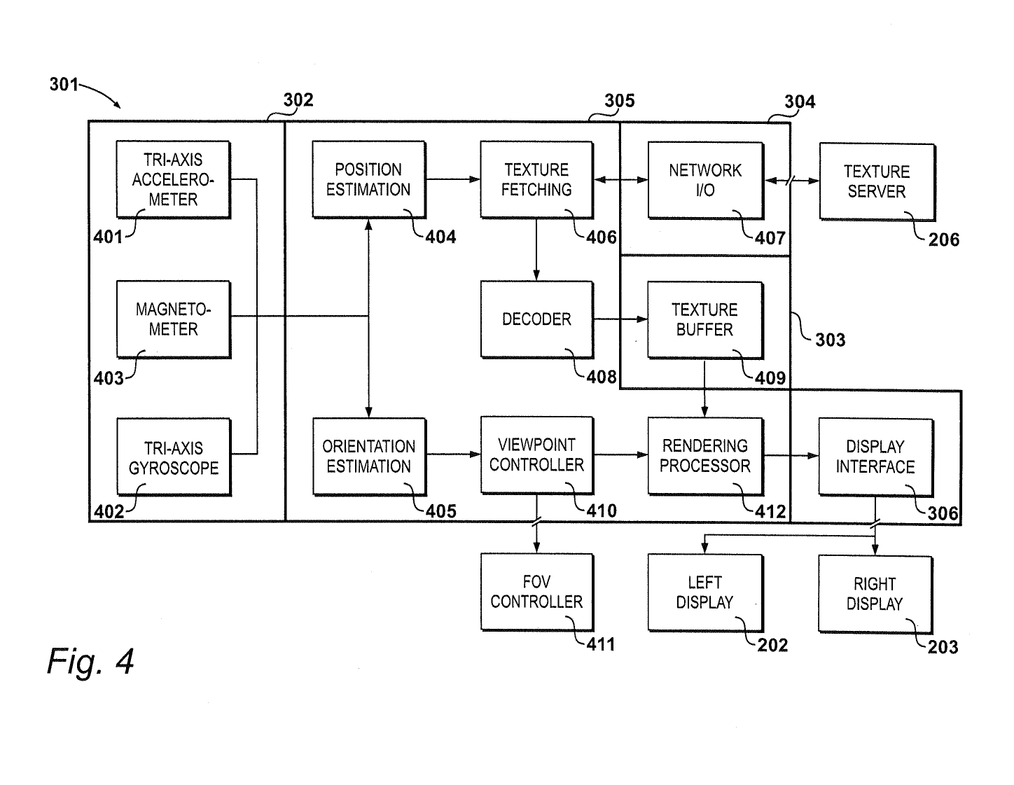

In a practical application of the present invention, it is proposed that the head-mounted display 101 presents a sequence of stereoscopic images to passengers on a roller coaster, so as to replace their actual experience of reality with either an augmented or fully virtual reality. The components within head-mounted display 101 to facilitate the generation of the stereoscopic imagery will be identified and described further with reference to FIGS. 3 and 4.

In operation, head-mounted display 101 generates the sequence of stereoscopic images by carrying out a rendering process. The rendering process involves, for each of the left and right stereoscopic images, texture mapping a sphere or a polyhedron, in which the render viewpoint is positioned, with a respective texture corresponding to the current position of the head-mounted display 101 on the path 105. The direction of the render viewpoint is determined by the orientation of the head-mounted display 101. The textures used in the rendering process are panoramic renderings of scenes along a path within a virtual environment, and are transferred from a static storage location 106 from which they may be retrieved, to the head-mounted display 101. Thus from the point of view of the head-mounted display 101, the textures are pre-rendered. In one embodiment, the textures are fully pre-rendered using animation software in conjunction with a render farm for example. In another embodiment, the textures are rendered in real-time, possibly using a game engine for example, and are therefore also pre-rendered for the head-mounted display 101.

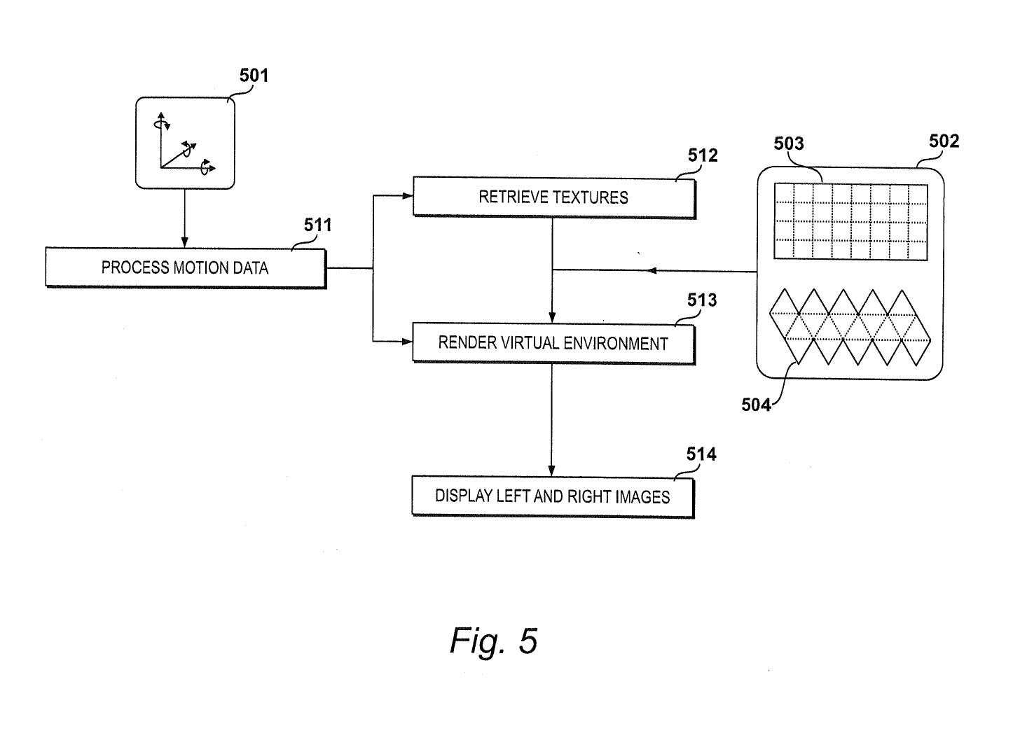

The rendering process within head-mounted display 101 operates at a higher refresh rate than the retrieval of the textures. This process and its advantages will be described further with reference to FIGS. 5 to 7.

In this way, motion along a path in a real environment will be experienced by a user of the head-mounted display 101 of the present invention as motion along the same path in a virtual environment. This aids the immersiveness of the virtual reality experience, as it is then possible to match a passenger's sense of motion with their visual experience. This overcomes a paradigm problem with virtual reality technologies, which is the tendency to induce nausea or simulator sickness due to the motion displayed in the virtual environment not correlating with the motion sensed by the other senses, particularly by the inner ear.

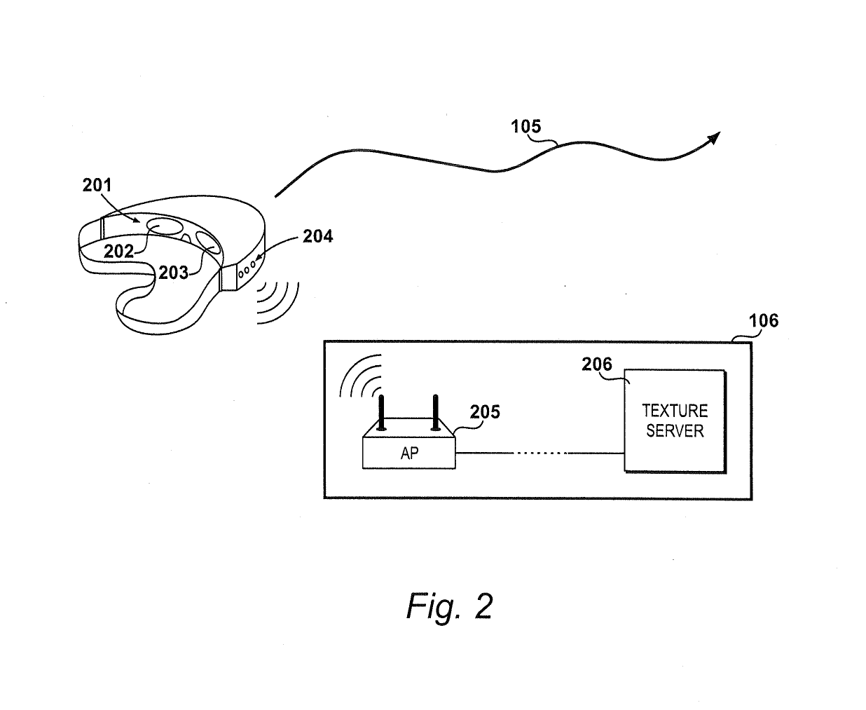

### FIG. 2

A diagrammatic representation is shown in FIG. 2 of communication between head-mounted display 101, which is travelling along the path 105, and storage location 106.

The head-mounted display 101 includes a stereoscopic display 201, comprising a left display 202 and a right display 203. Manually operable display controls 204 are also provided on the head-mounted display 101 to allow manual adjustment of brightness, contrast, focus, diopter, and the field of view etc. of the stereoscopic display 201. In the present embodiment, wireless communication with static storage location 106 is facilitated by inclusion of a wireless network data interface within the head-mounted display 101. The data interface and other components within the head-mounted display 101 are shown in and will be described further with reference to FIG. 3.

At the static storage location 106, a wireless access point 205 is provided, which operates using the same protocol as the wireless network interface within head-mounted display 101. Wireless access point 205 facilitates the transmission of pre-rendered textures to head-mounted display 101 from a texture server 206.

The texture server 206 in the present embodiment is arranged as a texture storage device. Internal storage in the texture server 206 has stored thereon pre-rendered, fully panoramic (i.e. 360 by 180 degree) left and right textures for a plurality of locations along the path 105 in a virtual environment. The textures for particular locations on the path 105 are retrieved in response to requests from head-mounted display 101.

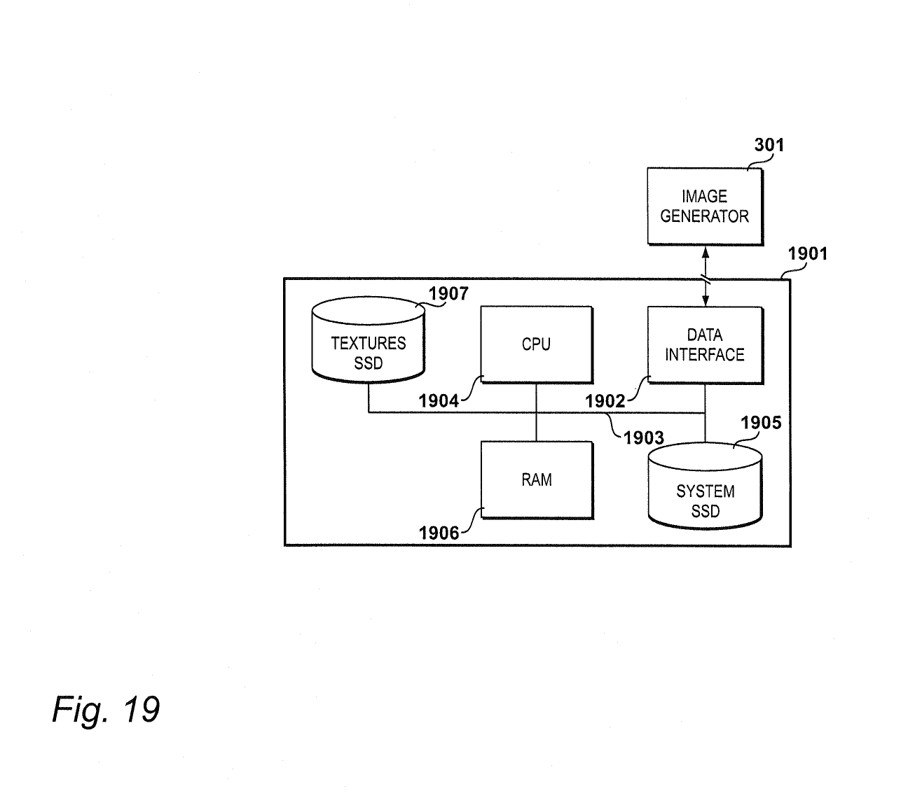

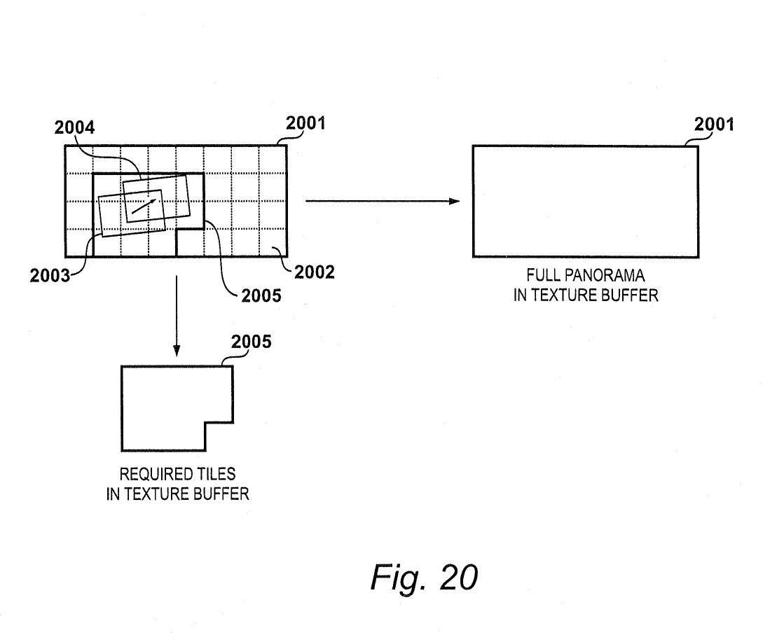

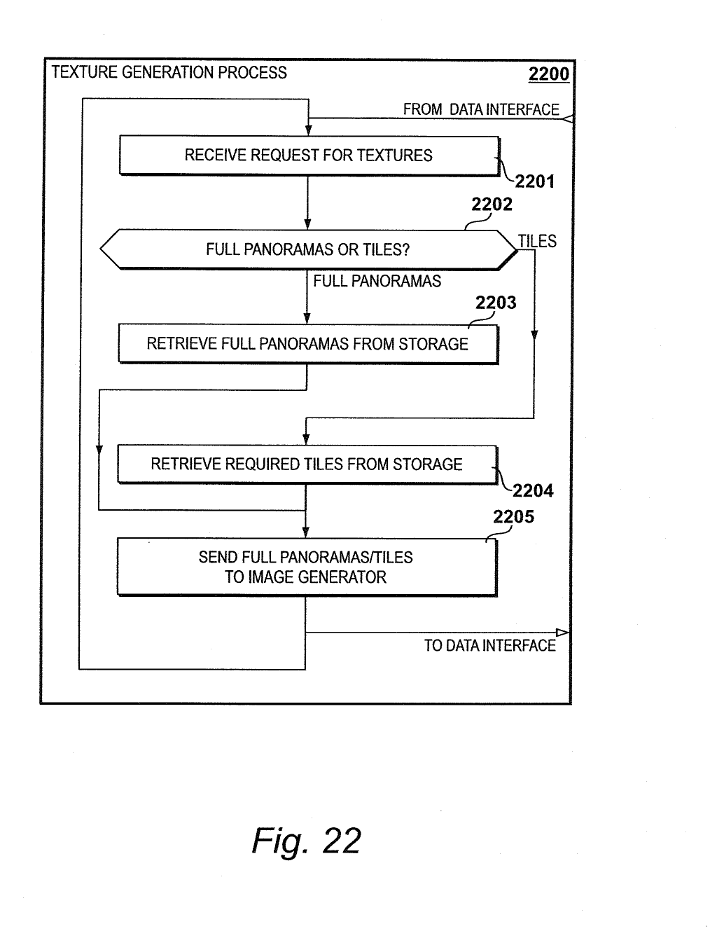

In the present embodiment, the textures are stored in a spatially compressed format, such as JPEG. Alternatively, the textures could be stored in with a degree of spatial and temporal compression, such as MPEG. In the present embodiment, textures are transmitted to the head-mounted display 101 in these compressed formats, such that the head-mounted display 101 receives spatially and/or temporally compressed textures. This assists in terms of reducing bandwidth requirements. Alternatively, the texture storage device can perform decompression prior to transmission if sufficient bandwidth is available. Components within this arrangement of texture server 206 will be described with reference to FIG. 19, with its operation being described with reference to FIGS. 20 and 22.

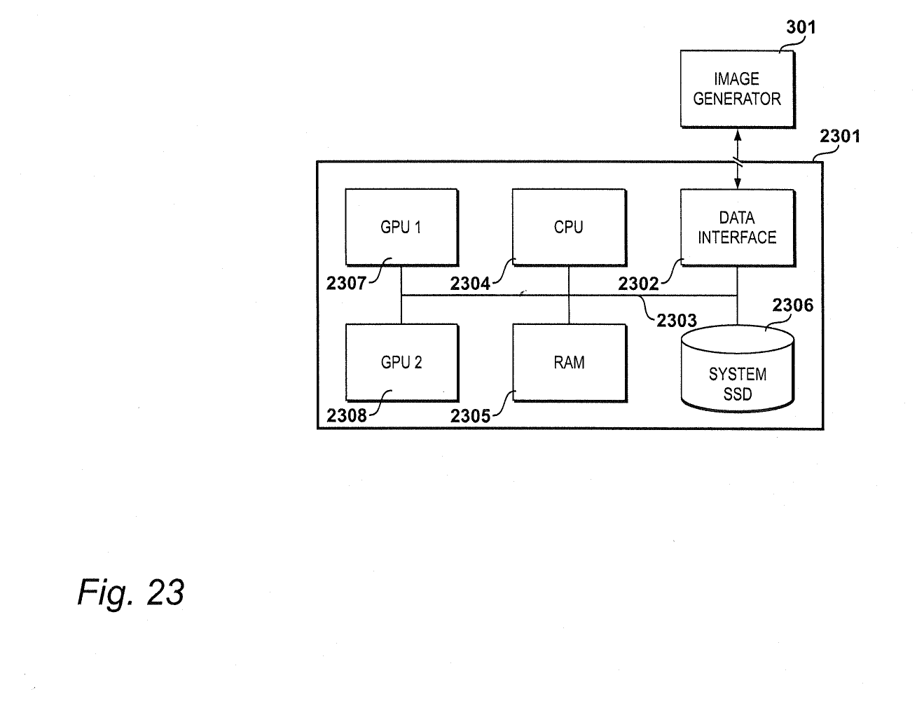

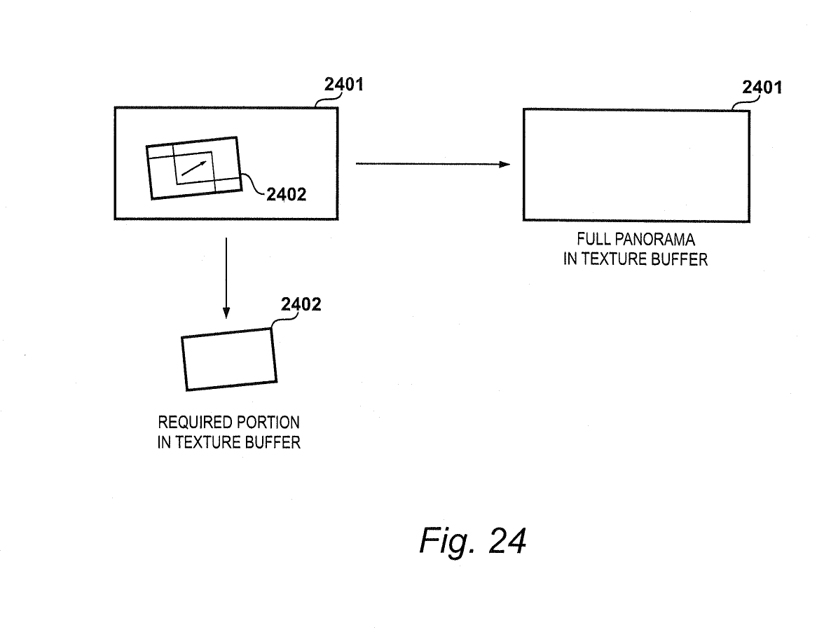

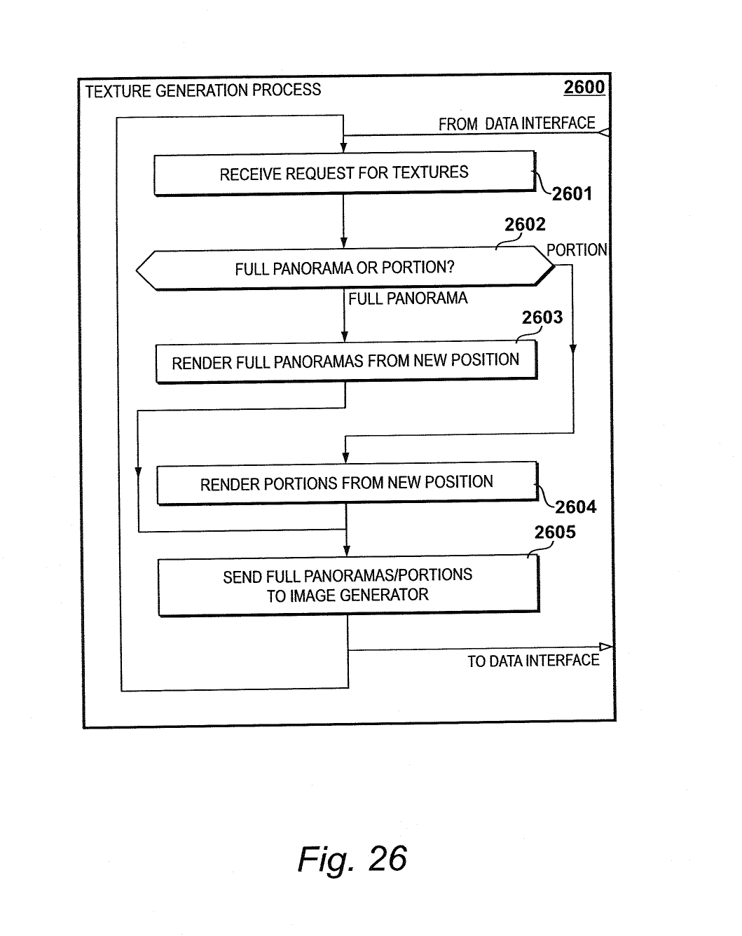

In an alternative embodiment, the texture server 206 is arranged as a texture generation device, which is configured to generate (and thereby pre-render) the left and right textures for particular locations on the path 105 in real time, in response to requests from head-mounted display 101. Components within this alternative arrangement of texture server 206 will be described with reference to FIG. 23, with its operation being described with reference to FIGS. 24 and 26.

Together, the head-mounted display 101 and the texture server 206 form a system for displaying to a wearer of the head-mounted display 101 a sequence of stereoscopic imagery depicting progression along the path 105 through a virtual environment when moving along that path in a real environment.

### FIG. 3

A diagrammatic illustration of the hardware components within the head-mounted display 101 is shown in FIG. 3.

The stereoscopic display 201 is shown, and includes the left display 202, the right display 203 and the display controls 204. Stereoscopic imagery is provided to the stereoscopic display 201 by an image generation device 301, which embodies one aspect of the invention. The image generation device 301 is in this embodiment configured as a sub-system of the head-mounted display 101, and is located within it. However, it is envisaged that in another embodiment, the image generation device 301 could be provided as a discrete, retrofit package for rigid and possibly removable attachment to the exterior of a head-mounted display. Reference to the motion, orientation and position of image generation device 301 herein therefore includes the same motion, orientation and position of head-mounted display 101.

The image generation device 301 includes motion sensors 302 to output an indication of the angular motion, and thus the orientation, of the head-mounted display 101. In the present embodiment, the motion sensors 302 also output an indication of the linear motion of the head-mounted display 101, and also an indication of the local magnetic field strength. The constituent sensor units to provide these outputs will be identified and described in terms of their operation with reference to FIG. 4.

Memory 303 is also provided within image generation device 301 to store data, which can be received via a data interface 304. In the present embodiment, the data interface 304 is, as described previously, a wireless network data interface, and operates using the 802.11 ac protocol. Alternatively, a longer range protocol such as LTE could be used.

Processing to generate the stereoscopic imagery is undertaken, in this embodiment, by a field-programmable gate array (FPGA) 305, which is configured to implement a number of functional blocks which are identified in and described with reference to FIG. 4.

Following generation of the stereoscopic imagery, the left and right images are outputted to the left display 202 and the right display 203 via a display interface 306, whose functionality will be described with reference to FIG. 4.

### FIG. 4

A block diagram detailing the functional components within image generation device 301 is shown in FIG. 4.

At a high level, the image generation device 301 predicts its future motion, including its next orientation and next position. It then proceeds to fetch from the texture server 206 the corresponding left and right textures for its next predicted position. The viewpoint from which the left and right images are rendered is altered based upon the prediction of its next orientation.

The motion sensors 302 in the present embodiment include a tri-axis accelerometer 401, a tri-axis gyroscope 402 and a magnetometer 403. The accelerometer 401 is of the conventional type, and is configured to sense the linear motion of image generation device 301 along three orthogonal axes, and output data indicative of the direction of motion of the device. More specifically, the accelerometer 401 measures the proper acceleration of the device to give measurements of heave, sway and surge. The gyroscope 402 is also of the conventional type, and is configured to sense the angular motion of image generation device 301 around three orthogonal axes, and output data indicative of the orientation of the device. More specifically, the gyroscope 402 measures the angular velocity of the device to give measurements of pitch, roll and yaw. The magnetometer 403 is configured to measure the local magnetic field of the Earth, and provide an output indicating the direction of and intensity of the field. This, in an example method of use, enables an initial value of the orientation of the device to be derived, upon which readings from the gyroscope can be added to calculate absolute orientation.

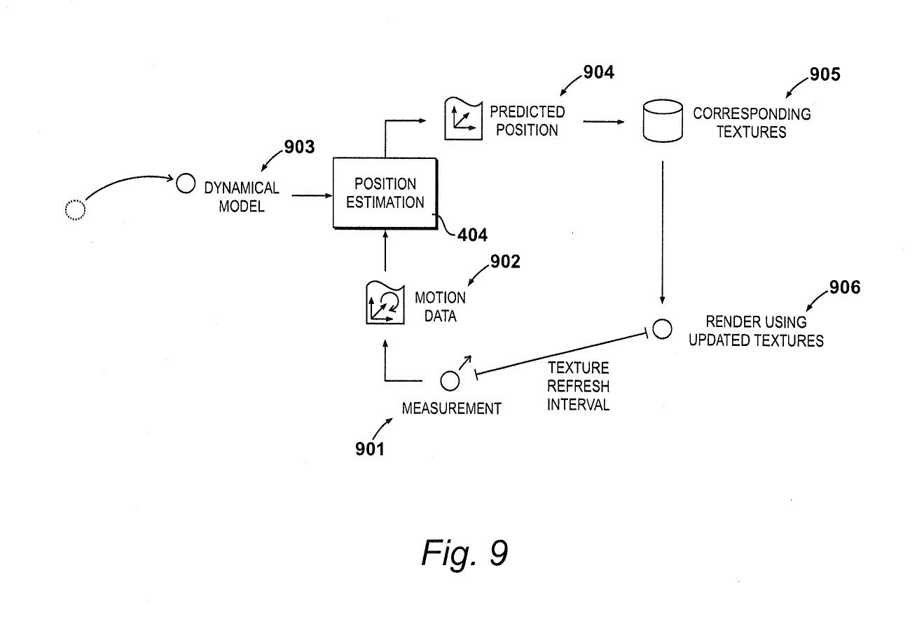

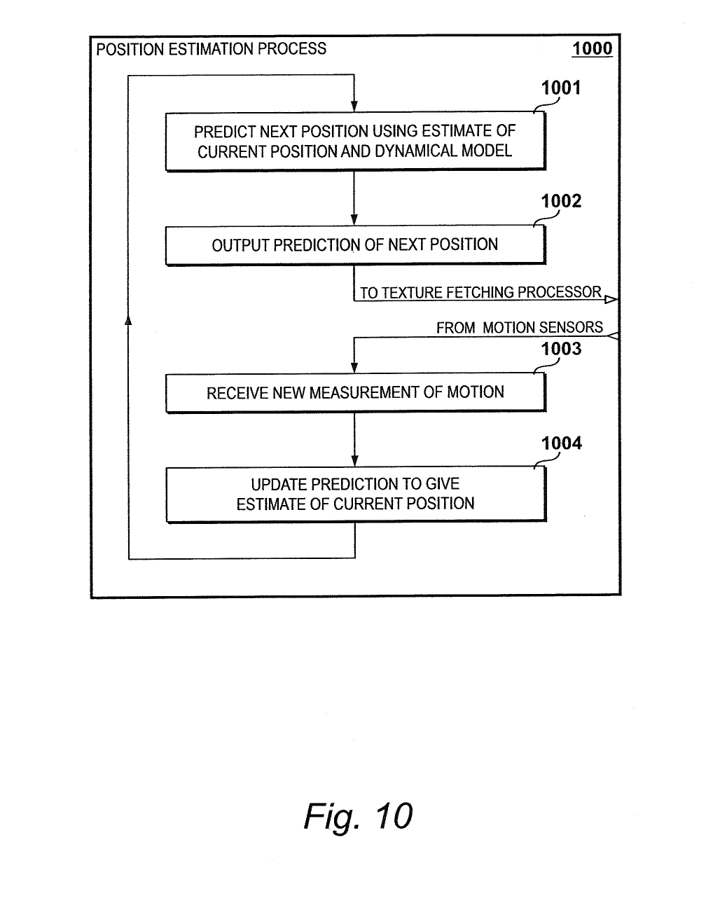

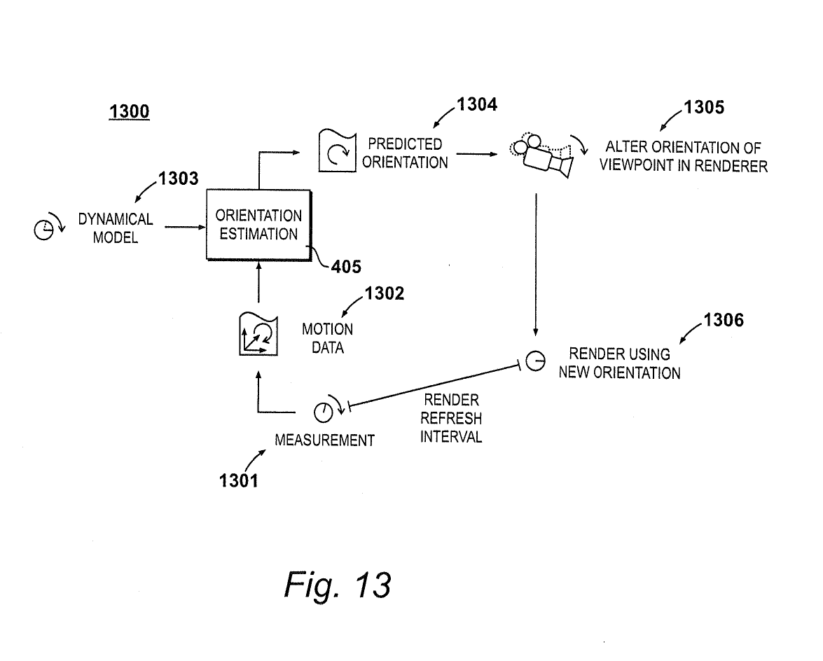

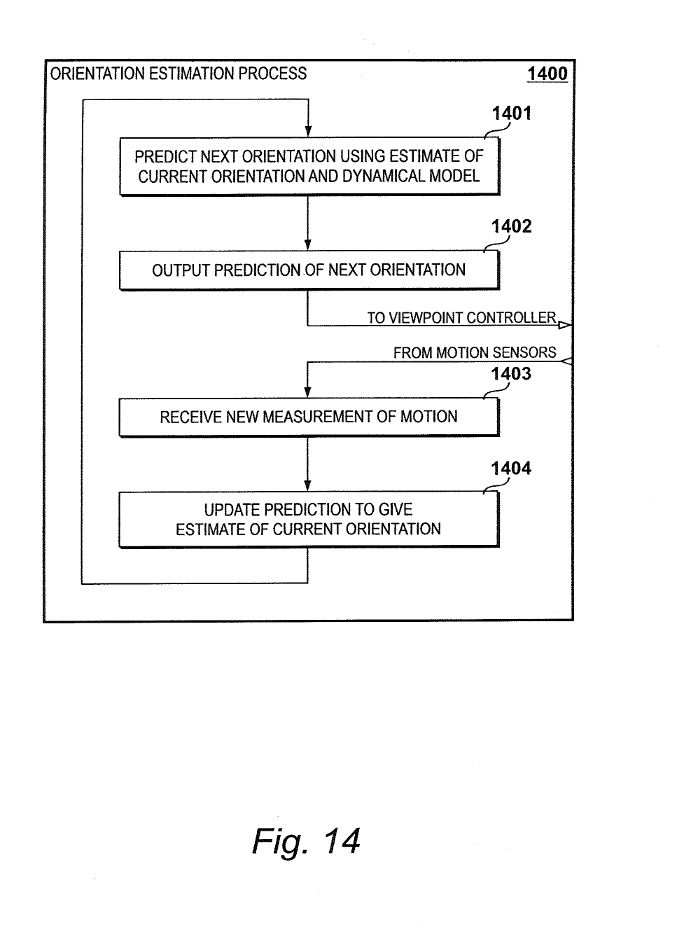

Thus the outputs of each of the accelerometer 401, the gyroscope 402 and the magnetometer 403 are provided to the FPGA 305. The output of at least the accelerometer 401 is used by a position estimation processor 404 to predict the position of the image generation device 301. The process of position estimation will be described with reference to FIGS. 9 and 10. The output of at least the gyroscope 402 is used by an orientation estimation processor 405 to predict the orientation of the image generation device 301. The orientation estimation process will be described with reference to FIGS. 13 and 14.

In a specific example, both of the position estimation processor 404 and orientation estimation processor 405 employ a sensor fusion procedure, which supplements their respective inputs from the accelerometer 401 and gyroscope 402 with the other ones of motion sensors 302 prior to position and orientation estimation. Thus, drift in the output of the gyroscope 402 can be corrected by taking into account readings from the accelerometer 401 and the magnetometer 403 to correct tilt drift error and yaw drift error respectively, for example. Readings from the gyroscope 402 and magnetometer 403 can be used to calculate the heading of the image generation device 301 which may be used to more accurately calculate the linear acceleration, as well. Kalman filtering of the known type for sensor fusion may be used to achieve this increased accuracy. Additional motion sensors could be provided and used in the position and orientation estimation processes, too, depending upon design requirements. Such sensors include altimeters, Global Positioning System receivers, pressure sensors etc.

In the present example, each one of the accelerometer 401, the gyroscope 402 and the magnetometer 403 provide their motion data at 600 hertz, and registers in each of the position estimation processor 404 and orientation estimation processor 405 are updated at this rate with the motion data for use.

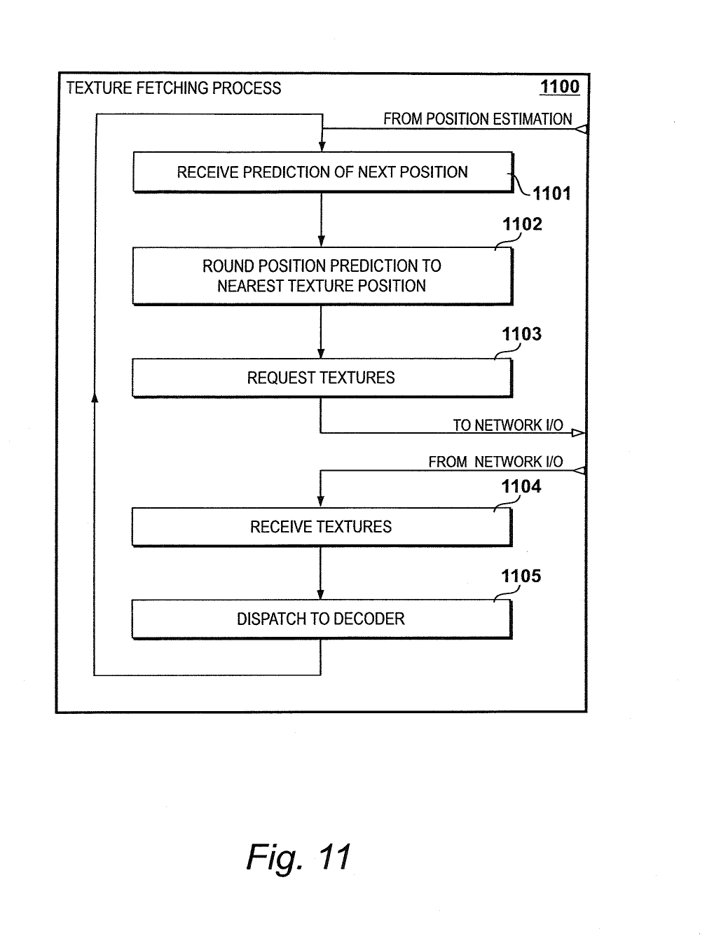

Considering first the output of position estimation processor 404, its output—the prediction of the next position of the image generation device 301—is provided to a texture fetching processor 406. The texture fetching processor 406 determines the appropriate left and right textures to request, via a network I/O processor 407 in the data interface 304, from texture server 206 on the basis of the prediction of the next position. Procedures employed by texture fetching processor 406 will be described further with reference to FIG. 11.

As described previously, in the present embodiment, the texture server 206 stores fully panoramic left and right textures. If the bandwidth available is sufficient, these full panoramas can be fetched by texture fetching processor 406, decoded by decoder 408 and stored in texture buffer 409. Alternatively, texture fetching processor 406 can employ a predictive approach to fetching only a portion of each of the required left and right textures, in which the portion retrieved from the texture server 206 is sufficient to take into account any changes in the orientation of image generation device 301 before the next update of the texture buffer 409. It will therefore be appreciated that reference to “textures” made herein that are stored in the texture buffer 409 means textures which can be either fully panoramic if sufficient bandwidth is available, or textures which are not fully panoramic but sufficient in extent to take into account changes in orientation. The methods of requesting the appropriate textures in this way will be described further with reference to FIGS. 20 and 24.

Following the fetching of the left and right texture pair, a decoder 408 is present in this embodiment to decode the compressed textures, whereupon they are stored in a texture buffer 409 in memory 303. Thus, as new left and right texture pairs are fetched, the texture buffer 409 is refreshed. The refresh rate of the texture buffer 409 is in the present embodiment 60 hertz. Thus, even if the textures transferred are of very high resolution, say of the order of 20 megapixels, then they may still be transferred by wireless communication methods and thus the head-mounted display 101 does not need to be physically tethered, meaning that higher bandwidth, wired communications technologies do not need to be used.

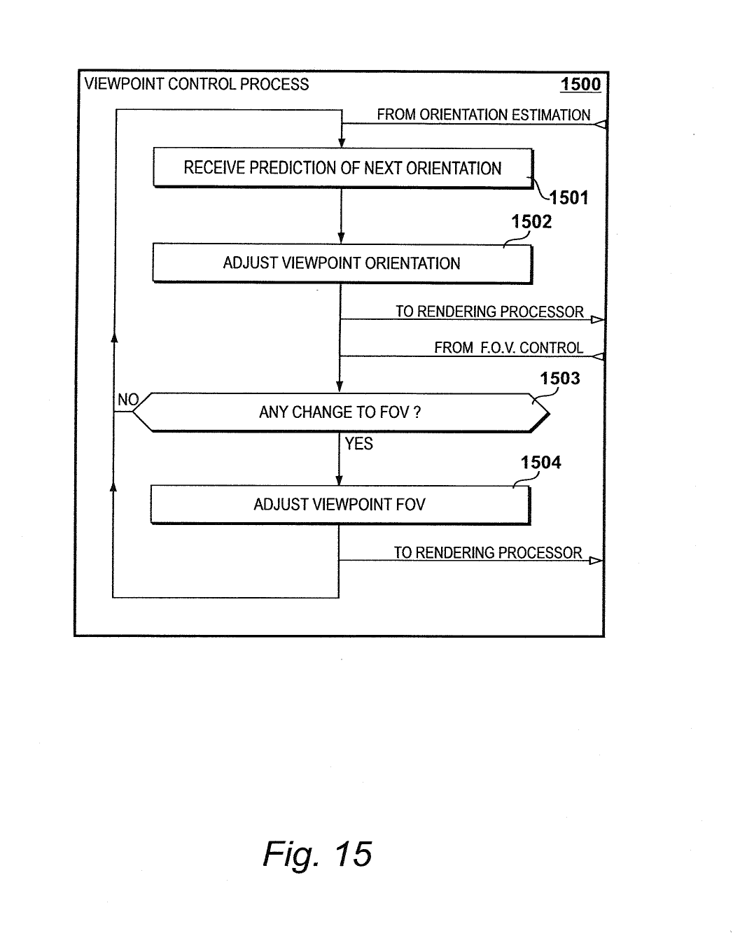

The output of orientation estimation processor 405—the prediction of the next orientation of image generation device 301—is provided to a viewpoint control processor 410 which calculates the appropriate adjustments to the properties of the left and right viewpoints in a rendering processor 412. In the present embodiment, the viewpoint controller 410 can adjust both the orientation of the viewpoint, in response to predictions received from the orientation estimation processor 405, and the field of view used when rendering, based on adjustments received from a field of view control 411, which forms part of the display controls 204. In this way, a wearer of the head-mounted display 101 can choose the field of view for the stereoscopic imagery presented to them. The process carried out by the viewpoint controller 410 to effect these adjustments to the rendering processor 412 are described further with reference to FIG. 15.

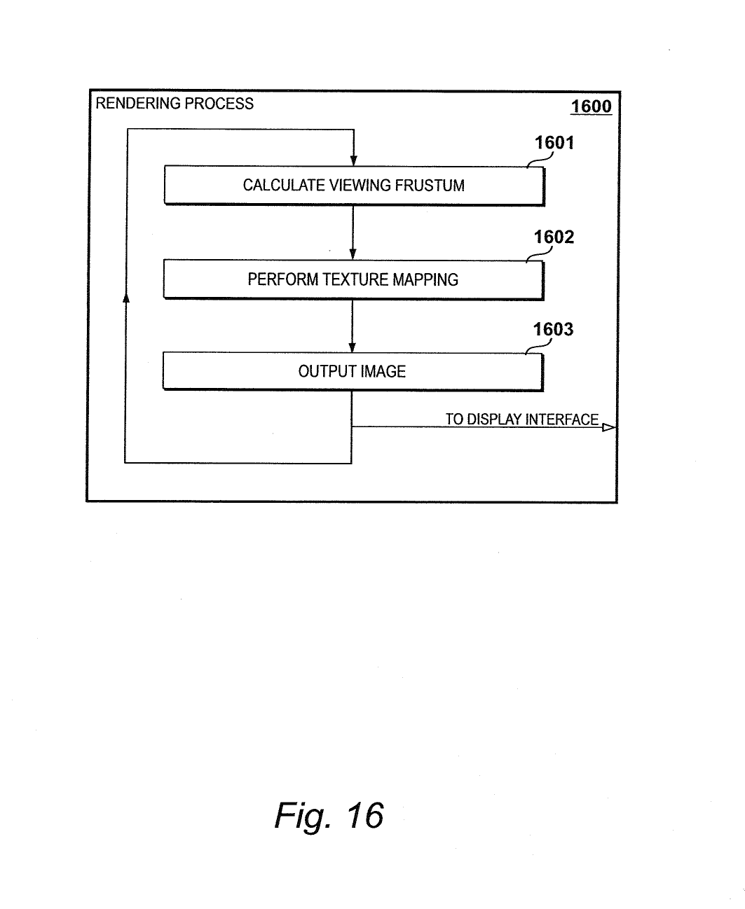

Rendering processor 412 is configured to render the left and right images for display in the respective left and right displays 202 and 203, from the viewpoints determined by viewpoint controller 410. The rendering processor 412 employs a texture mapping process, in which the left and right pre-rendered textures in the texture buffer 409 are mapped onto respective spheres or polyhedrons. The processes carried out by the rendering processor 412 are described further with reference to FIGS. 16 to 18. The rendering processor 412 is configured to produce new left and right images at a rate of 600 hertz in the present embodiment.

Output of the left and the right images from the rendering processor 412 is performed via the display interface 306. In the present embodiment, the display interface 306 is simply appropriate connections from FPGA 305 directly to left display 202 and right display 203, which are in the present embodiment active matrix liquid crystal displays having a refresh rate of 600 hertz. In order to minimize latency, the display interface 306 simply acts as a direct interface between the rendering processor 412 and the active matrixes of the displays. In this way, no frame buffer is required, and so latency is minimized in terms of the amount of time taken between the availability of pixel data from the rendering processor 412 and the update of the display.

In an alternative embodiment, in which the image generation device 301 is configured as a separate discrete package for attachment to a head-mounted display, the display interface 306 could be configured as a physical port using a standard high speed interface, to output the left and the right images via a high bandwidth connection such as DisplayPort®.

It will be appreciated by those skilled in the art that a central processing unit and graphics processing unit could be provided as an alternative to FPGA 305, with software being stored in memory 303 to implement the functional blocks identified in FIG. 4.

### FIG. 5

A high level overview of processes undertaken in the generation of stereoscopic imagery by image generation device 301 is shown in FIG. 5.

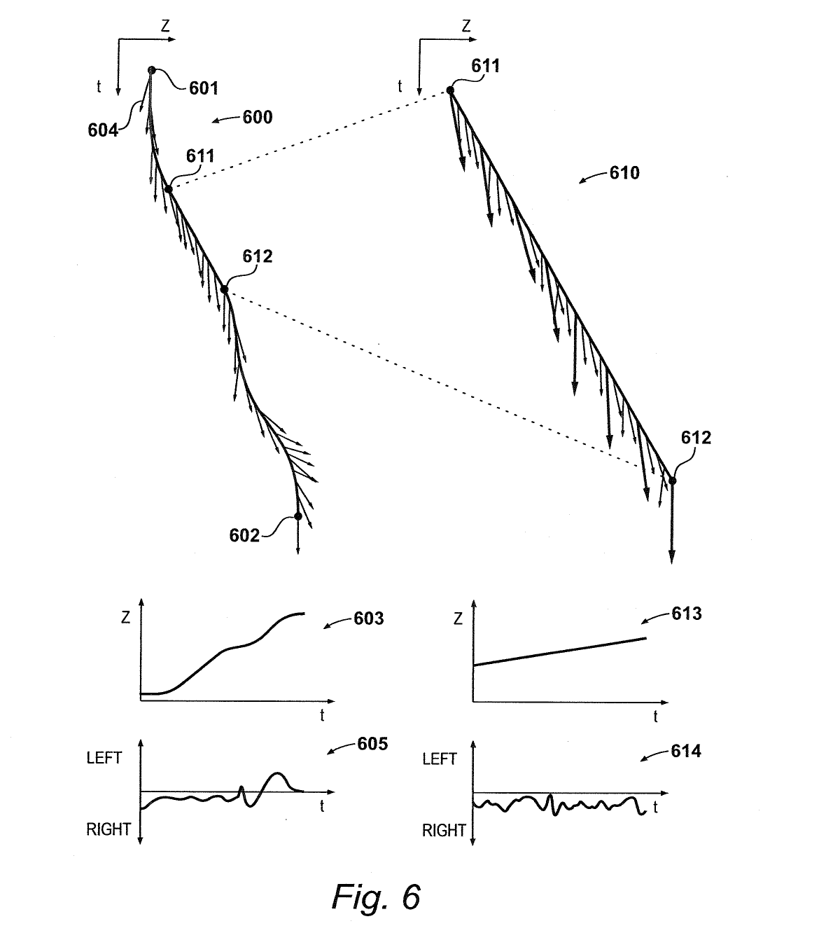

Motion data 501 is produced by motion sensors 302, an example of which will be described further with reference to FIG. 6. Processing is performed by FPGA 305 upon this motion data at step 511 to then allow textures to be retrieved at step 512 from texture server 206. The textures 502 are in one embodiment stored at the texture server 206 as equirectangular projections 503, and in another embodiment icosahedral projections 504. Both of these projections lend themselves well to being mapped onto spheres. Alternatively the textures could be stored as cube maps for mapping onto cubes. Another advantage to the two projections 503 and 504 is that they can easily be split into indexed tiles. In this way, prediction of only the required portions of the textures 502 can be performed and the tiles corresponding to those portions retrieved from texture server 206. A suitable process for retrieving textures in this way will be described further with reference to FIG. 20.

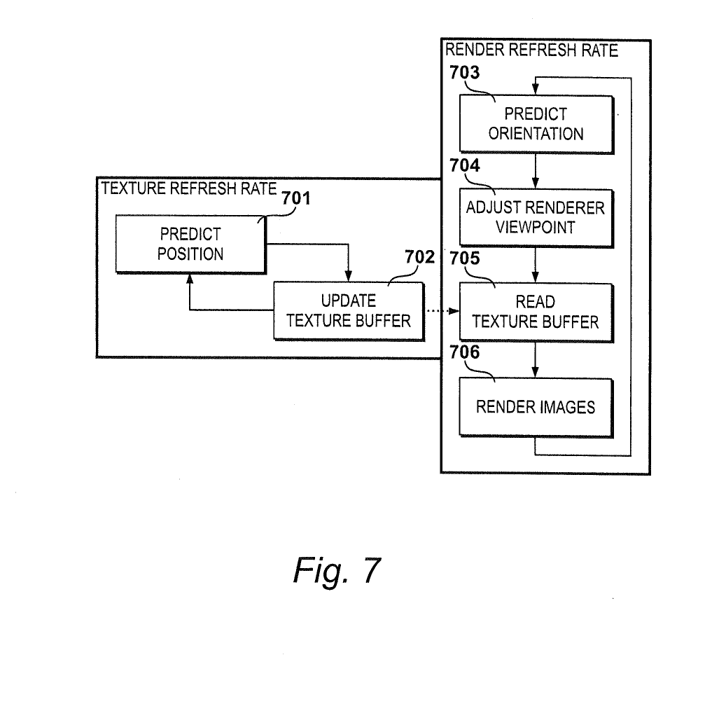

In any event, following retrieval of the correct left and right textures at step 512, processing is performed by FPGA 305 at step 513 in which a virtual environment is rendered. The virtual environment is rendered by texture mapping the left and right pre-rendered textures on to either spheres or polyhedrons, with the particular textures and rendering viewpoint being determined by the motion data produced. The rendering process will be described further with reference to FIG. 7. The rendered left and right images are then displayed using the stereoscopic display 201 at step 514.

### FIG. 6

As described previously with reference to FIGS. 1 and 4, the generation of stereoscopic imagery, that is the left and right images by rendering processor 412 is carried out at a higher rate than that at which the texture buffer 409 is refreshed. In the present embodiment, the left display 202 and the right display 203 are refreshed at 600 hertz, whilst the texture buffer is refreshed with new left and right textures at 60 hertz. Thus the present invention decouples the refreshing of the scene in the virtual environment in which a wearer of head-mounted display 101 finds themselves, from the orientation of the camera viewpoint in rendering processor 412 for the generation of the imagery presented to them. In this way, very high frame rates are enabled in the head-mounted display 101.

An example of the motion data produced by motion sensors 302 is shown in FIG. 6, which aids an explanation as to why the present invention employs this decoupled approach to rendering a virtual environment.

The progression of a wearer of head-mounted display 101 along path 105 along a Z-axis with respect to time is illustrated in FIG. 6. The progression is shown at 600 from a first point 601 to a second point 602. An enlargement of the sub-portion 610 between two intermediate points 611 and 612 is also illustrated. Thus the linear motion of the wearer can be described as one in which it initially accelerates, relative to the Z-axis, to a constant speed from point 601 to point 611. The speed is maintained until point 612, whereupon a deceleration, an acceleration and a further deceleration are experienced until point 602. Plot 603 shows the linear motion in the Z direction with respect to time.

In order to exemplify the orientation of the head-mounted display 101, consider the direction of a tangent at any point to the line drawn between point 601 and 602 as representing the head-mounted display 101 facing forwards, i.e. in the direction of the Z axis. Then the arrows, such as arrow 604 at point 601, define the actual orientation. Thus at point 601, the head-mounted display 101 is orientated to the right as if viewed from above. Plot 605 shows the degree of deviation of the head-mounted display 101 from looking straight ahead, i.e. either orientated left or right, against time. It will be seen here that in this example the frequency with which the orientation changes shown in plot 605 is much higher than that of the position as shown in plot 603.

Indeed, when considering sub-portion 610, it becomes even clearer how the orientation can of course vary at a still considerable rate, even under constant linear motion. This is clearly shown in plot 613 which shows the linear motion between points 611 and 612 along the Z axis with respect to time, with plot 614 showing the still high frequency change in orientation of the head-mounted display 101 despite the constant linear motion.

Angular head motion tends to be faster and of much higher acceleration than linear head motion. In recognition of this, the present invention provides a technical approach to improving the refresh rate of the display, to take account of this angular motion, without simply proposing an increase in processing capability to render new frames at a higher rate, which could cause issues in terms of power consumption, cooling, size and weight etc.

### FIG. 7

By appreciating that linear motion occurs at a much lower rate than angular motion in head-mounted display 101, the present invention separates the processing steps to be carried out to reflect those types of motion. Thus FIG. 7 illustrates the segregation of processing by refresh rate.

At step 701, the position of head-mounted display 101 is predicted by position estimation processor 404. Following this, the texture buffer 409 is updated by texture fetching processor 406 at step 702. In the present embodiment, these two steps are carried out at a rate such that the texture buffer 409 is refreshed at 60 hertz. Thus, left and right textures defining respective pre-rendered versions of a scene in the virtual environment are retrieved at a first refresh rate, where the textures correspond to a predicted position of head-mounted display 101 on its path. In the envisaged deployment of the present invention, this is the path taken by the roller coaster cart 104 on the path 105. In an embodiment, only a portion of the fully panoramic textures available from texture server 206 are retrieved therefrom so as to reduce bandwidth requirements.

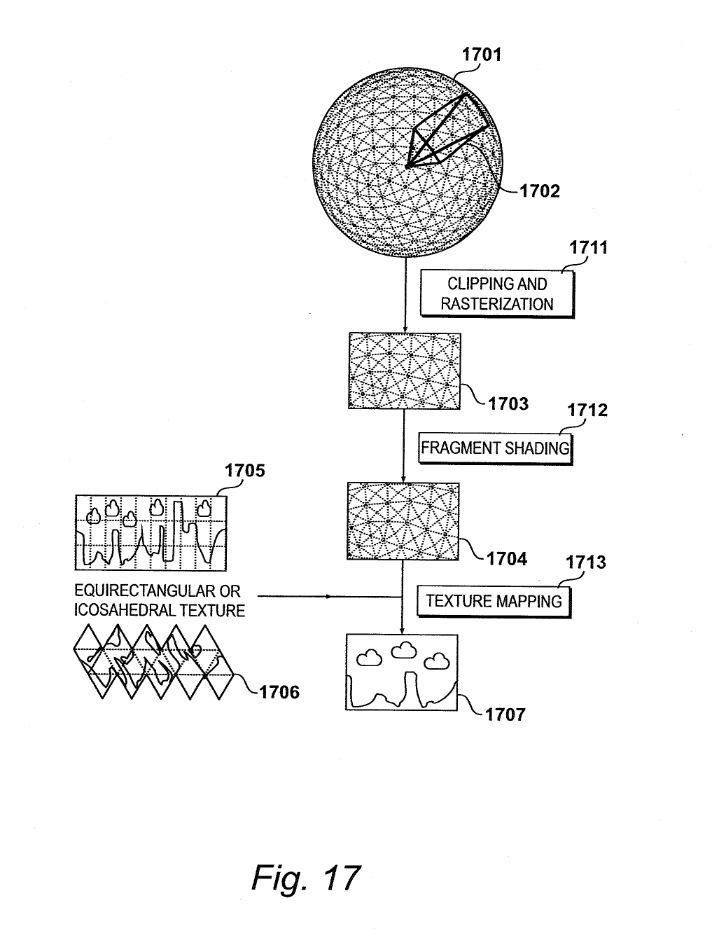

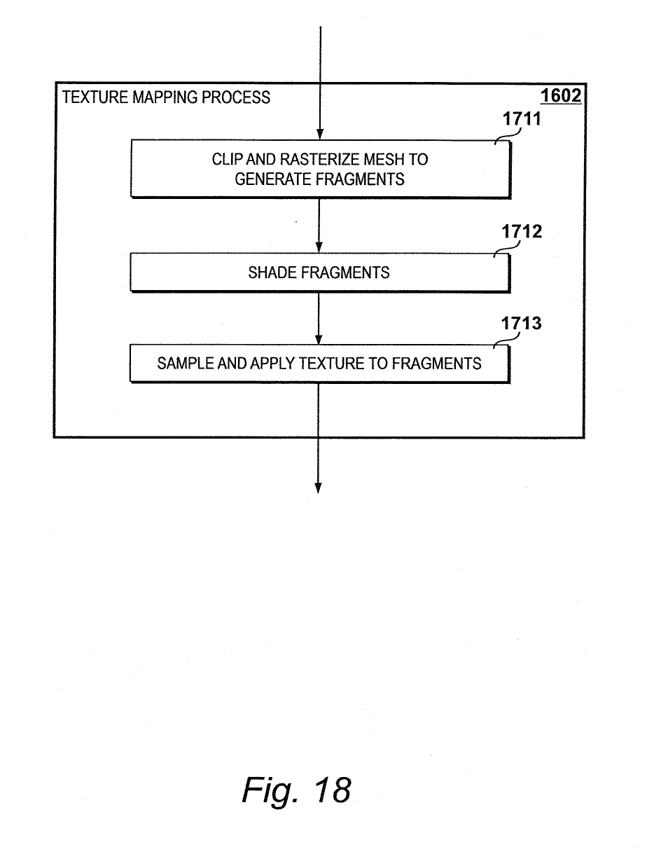

At step 703, the orientation of head-mounted display 101 is predicted by orientation estimation processor 405. Following this, the viewpoint of the renderer is adjusted at step 704 by viewpoint controller 410. The rendering processor 412 then proceeds to read the texture buffer 409 at step 705, after which it renders the left and right images for display at step 706. Steps 703 to 706 are carried out in the present embodiment such that images are produced at a rate of 600 hertz. Thus, left and right images rendered from respective render viewpoints are displayed by stereoscopic display 201 at a second refresh rate. As will be described further with reference to FIGS. 17 and 18, the rendering is achieved by mapping the left and right textures onto respective spheres or polyhedrons, where the render viewpoints are based on the predicted orientation of the head-mounted display 101.

The first refresh rate is lower than the second refresh rate, such that the orientation of the viewpoint within the virtual environment can change multiple times for each change in linear motion. In this way, the present invention facilitates an increase in temporal resolution, which allows a reduction in strobing, which is a major contributor to feelings of nausea when using head-mounted displays. In addition, due to the reduced rendering requirements, images can still be displayed with a high spatial resolution to reduce smear. Thus, by increasing temporal resolution and maintaining high spatial resolution, strobing, smear and judder are minimized.

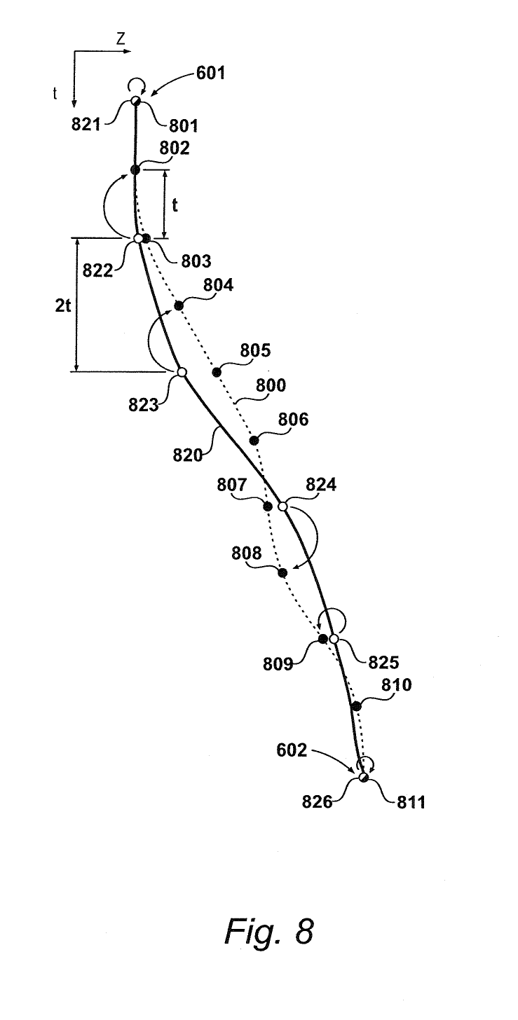

### FIG. 8

A graphical representation of the process employed by the present invention to select textures from texture server 206 is show in FIG. 8.

As described previously, the texture fetching processor 406 operates to fetch textures in the present embodiment at a rate of 60 hertz, so as to enable refreshing of the texture buffer 409 at this rate. Thus, the position of head-mounted display 101 is predicted by position estimation processor 404 60 times per second, regardless of its velocity. In addition, and as described previously, in the present embodiment the texture server 206 is configured to operate as a texture storage device, and store pre-rendered left and right textures for each one of a plurality of locations along the path 105, which respectively define a plurality of scenes in said virtual environment. Together, the scenes depict progression along the path.

In order to ensure a good correlation between the textures retrieved from texture server 206, which correspond to a fixed location on the path 105, and the predicted position, which can be at any location along the path 105, twice the number of textures are available at the texture server 206 than will ultimately be requested by the texture fetching processor 406. Thus, textures are effectively available in the present embodiment at a rate of 120 hertz. This reduces what is in effect quantization distortion, due to the mapping of predicted position of head-mounted display 101 to fixed locations for which the textures have been pre-rendered. This process is illustrated in FIG. 8.

Two different progressions of head-mounted display 101 are shown in FIG. 8, between points 601 and 602 previously described with reference to FIG. 6. An expected progression in the Z direction along path 105 with respect to time is shown by dashed line 800, with an actual progression shown by solid line 820.

Dashed line 800 shows the progression expected along path 105 when the left and right pre-rendered textures were rendered, with filled circles 801 to 811 showing points at which textures are available. The textures are available at intervals of time t, which is in the present embodiment about 8.3 milliseconds, corresponding to a rate of 120 hertz. Positions predicted by position estimation processor 404 lie on the solid line 820 and are signified by unfilled circles 821 to 826. The time interval between the predictions of position is 2t, which in the present embodiment is 16.6 milliseconds, corresponding to a rate of 60 hertz. The total distance traveled in the Z direction is the same, with the total time taken being the same, between points 601 and 602. However, the velocity profiles of each of the expected and actual progressions of head-mounted display 101 are different.

Thus, at the starting point 601, the prediction of position 821 corresponds to texture point 801. However, after time 2t has elapsed, the prediction of position 822 corresponds in fact more closely to texture point 802, which is located after only t has elapsed on the dashed line 800 defining the expected progression of head-mounted display 101. Texture point 802 is thus the position in the Z direction for which textures should be retrieved at this time. A similar situation exists after another 2t of time has elapsed, with the prediction of position 823 corresponding more closely to texture point 804 rather than texture point 805. After time 6t has elapsed however, head-mounted display 101 is progressing further than expected, and so the closest texture point to predicted position 824 is texture point 808, which is located at time 7t on the dashed line 800 defining the expected progression of head-mounted display 101. At the end point 602, a similar situation exists to that at starting point 601 with the prediction of position 826 matching texture point 811.

By rounding the prediction of the position of the head-mounted display 101 to the closest texture point in terms of position on the path, rather than elapsed time along the path, differences in velocity can be taken into account. This is particularly advantageous in deployments of the present invention such as the environment shown in FIG. 1, in which the velocity of the cart 104 on the rollercoaster 103 will vary slightly from run to run. As shown in FIG. 8, the storage of twice the number of left and right textures in texture server 206 mitigates against quantization error. For example, consider textures being made available at the same rate as the update of the texture buffer 409, i.e. at 60 hertz. Predicted position 822 in this event is closest to texture point 803. However, texture point 803 would be the closest to predicted position 823 as well. Thus, the same left and right textures would be used for rendering for two consecutive refreshes of the texture buffer 409. This use of the same textures over two updates would have a particularly unwanted effect if it occurred at high velocity, as the wearer of head-mounted display 101 would be experiencing linear motion, but would get no feedback of this through stereoscopic display 201. By providing double the number of textures than is delivered to the head-mounted display 101, the instances of this unwanted quantization error are minimized.

### FIG. 9

In order to predict the position of the head-mounted display 101, position estimation processor 404 employs, in the present embodiment, a Kalman filter. In alternative embodiments, other types of processing schemes could be used to enable position prediction, such as a particle filter.

An illustration of the procedure used for predicting position is shown in FIG. 9 to enable rendering based on a prediction of the position of the head-mounted display 101.

At step 901, a measurement of the linear motion of head-mounted display 101 is generated by the motion sensors 302. At step 902, data describing the motion of the head-mounted display 101 is passed to the position estimation processor 404. In an embodiment, this includes data describing the angular motion of the head-mounted display 101 in addition to its linear motion to enable more precise estimation.

At step 903, and reference is made to a pre-defined dynamical model describing the motion of the head-mounted display 101 based upon the current motion data. In the exemplary deployment, the dynamical model used by the position estimation processor 404 is derived from a number of test runs along the track of the roller coaster 103, defining dynamics for each position. Alternatively, the model could be a constant acceleration model.

The position estimation processor 404 proceeds to process the motion data from step 902 in combination with reference to the dynamical model to produce a prediction of the next position of the head-mounted display 101 at step 904. The process of producing this prediction will be described with reference to FIG. 10. At step 905, the left and right textures corresponding to the prediction of the next position are retrieved from the texture server 206 by texture fetching processor 406, the process of which will be described with reference to FIG. 11. After updating the texture buffer 409 with the newly fetched left and right textures, rendering can proceed using the new textures at step 906. All of steps 901 to 906 are arranged to occur during the texture refresh interval, which in the present embodiment is about 16.6 milliseconds—a rate of 60 hertz.

### FIG. 10

The position estimation process 1000 used by position estimation processor 404 is detailed in FIG. 10. This process is recursive, and will be familiar to those skilled in the art as a Kalman type filter, in which an a priori state estimate is generated during a predict processing phase, which is then improved during an update processing phase to generate an a posteriori state estimate.

Thus, at step 1001, a prediction is made as to the next position of the head-mounted display 101 using the estimate of the current position in combination with the dynamical model. At step 1002, this prediction of the position is outputted to the texture fetching processor 406.

At step 1003, a new measurement of the motion of head-mounted display 101 is received, which is then used at step 1004 to update the prediction of the current position generated at step 1001. This provides an estimate of the current position. In this way, the prediction of the position of the head-mounted display 101 for a particular moment in time is corrected by a measurement of motion from which the actual position at that moment in time can be inferred.

### FIG. 11

The texture fetching process 1100 used by texture fetching processor 406 is detailed in FIG. 11.

Following receipt at step 1101 of the prediction of the position of the head-mounted display 101 outputted at step 1002, the prediction is rounded in the present embodiment at step 1102 to the nearest corresponding texture position, thus implementing the illustrative example of FIG. 9. This rounding procedure is in the present embodiment performed by a uniform quantizer. In a specific embodiment, a degree of dither is applied to the prediction of the position of the head-mounted display 101 prior to rounding to reduce quantization distortion. The rounded position is then used during step 1103 to request the corresponding left and right pre-rendered textures from texture server 206, via network I/O processor 407.

Alternatively, the raw prediction of the position can be outputted instead, with rounding being performed by texture server 206.

After texture server 206 supplies the requested textures (one process of which will be described with reference to FIG. 20, and another process being described with reference to FIG. 22), they are received from network I/O processor 407 at step 1104, whereupon they are dispatched in this embodiment to the decoder 408 for decompression at step 1105. Following decompression, they are then stored in the texture buffer 409 in uncompressed form. If the textures are received in an uncompressed bitmap format, then they can instead be written directly into the texture buffer 409.

Thus, by predicting the position of the head-mounted display 101, it is possible to anticipate its linear motion and to determine which left and right pre-rendered textures need to be retrieved from texture server 206. They may then be transferred to the head-mounted display 101, and the texture buffer 409 refreshed. By operating this process at a rate of, in the present embodiment, 60 hertz, any latency due to the transfer of the textures via a network is less problematical. This rate could, in an embodiment, be adaptive to deal with network congestion, for example, with appropriate modifications being made on-the-fly to the time step in the Kalman filter used for position prediction.

Additionally, as described previously, in an alternative embodiment only a portion of the pre-rendered left texture and a portion of the pre-rendered right texture are transferred from texture server 206 to the image generator 301. This is because there is a limit on the extent to which the orientation of the head-mounted display 101 can change during the texture refresh interval. For example, if it is estimated that the head-mounted display 101 can change orientation at a rate of up to 600 degrees per second, then at the exemplary texture refresh rate of 60 hertz, the maximum change to the orientation is 10 degrees in any direction over the update interval. Thus, in such an example, the portion of the pre-rendered textures which needs to be retrieved from the texture server 206 is that corresponding to the current field of view, which may be derived from the setting of the field of view control 411, plus 10 degrees in each direction. This can allow a substantial saving in terms of the bandwidth required to transfer the pre-rendered textures.

Such a process, if incorporated into the system, performed during step 1103, depends upon the mode of operation of the texture server 206. Thus the methods by which textures are requested, retrieved and transferred from the texture server 206 will be described further with reference to FIGS. 19 to 26.

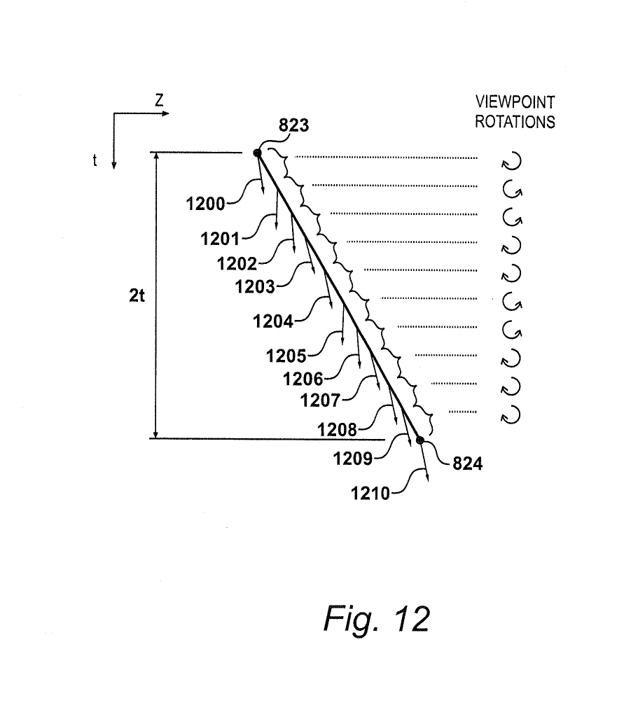

### FIG. 12

As described previously, the present invention uses a decoupled approach to first refreshing the texture buffer 409 with new textures, and second refreshing the viewpoint from which the stereoscopic imagery is rendered by rendering processor 412. In the present embodiment, the rate at which imagery is rendered is ten times higher than that at which the textures are refreshed. This is an appreciation of the fact that the rate at which the orientation of one's head changes tends to be much higher than that at which its position changes.

The example shown in FIG. 12 illustrates the changes to the orientation of the head-mounted display 101 over a time period 2t, between predicted positions 823 and 824. Between these positions, linear motion is substantially constant, but the orientation of the head-mounted display 101 is still varying. Thus, by making predictions as to the orientation of the head-mounted display 101 in much the same way as is done with its position, albeit at a higher rate, appropriate corrections can be made to the viewpoint in the rendering processor 412 by viewpoint controller 410.

Thus an initial prediction of the orientation 1200 at predicted position 823 is followed by ten further predictions of the orientation 1201 to 1210. This results in ten viewpoint rotations being derived for the viewpoint orientation by viewpoint controller 410 within the time period 2t.

### FIG. 13

In order to predict the orientation of the head-mounted display 101, orientation estimation processor 405 employs, in the present embodiment, a Kalman filter in a similar way to position estimation processor 404. Again, in alternative embodiments, other types of processing schemes could be used to enable position prediction, such as a particle filter.

An illustration of the prediction process 1300 is shown in FIG. 13 to enable rendering based on a prediction of the orientation of the head-mounted display 101.

At step 1301, a measurement of the angular motion of head-mounted display 101 is generated by the motion sensors 302. At step 1302, data describing the motion of the head-mounted display 101 is passed to the orientation estimation processor 405. In an embodiment, this includes data describing the linear motion of the head-mounted display 101 in addition to its angular motion as part of a sensor fusion routine.

At step 1303, reference is made to a pre-computed dynamical model describing the motion of the head-mounted display 101 based upon the current motion data. In the exemplary deployment, the dynamical model used by the orientation estimation processor 405 is derived from empirical testing of how wearers of head-mounted displays tend to alter the orientation of their heads when riding roller coaster 103. Alternatively, the model could be a constant angular acceleration model.

The orientation estimation processor 405 proceeds to process the motion data from step 1302 in combination with reference to the dynamical model to produce a prediction of the next orientation of the head-mounted display 101 at step 1304. The process of producing this prediction will be described with reference to FIG. 14. At step 1305, the viewpoint in the rendering processor 412 is reconfigured by viewpoint controller 410, the process of which will be described with reference to FIG. 15. After updating the viewpoint in rendering processor 412 according to the change in orientation predicted by orientation estimation processor 405, rendering is performed at step 1306 using this new orientation.

All of steps 1301 to 1306 are arranged to occur during the render refresh interval, which in the present embodiment is about 8.3 milliseconds—a rate of 600 hertz.

### FIG. 14

The orientation estimation process 1400 used by orientation estimation processor 405 is detailed in FIG. 14. In a similar way to the process used by position estimation processor 404, the process is recursive, and will be familiar to those skilled in the art as a Kalman type filter, in which an a priori state estimate is generated during a predict processing phase, which is then improved during an update processing phase to generate an a posteriori state estimate.

At step 1401, a prediction is made as to the next orientation of the head-mounted display 101 using the estimate of the current orientation in combination with the dynamical model. At step 1402, this prediction of the orientation is outputted to the viewpoint controller 410.

At step 1403, a new measurement of the motion of head-mounted display 101 is received, which is then used at step 1404 to update the prediction of the current orientation generated at step 1401 to give an estimate of the current orientation. This procedure involves taking into account the reading of angular velocity of the gyroscope 402 at the current point in time, from which the angular displacement since the last reading may be computed. As described previously, a sensor fusion process may be employed during this phase in one embodiment so as to enhance the accuracy of the measurement, by taking into account readings from the accelerometer 401 and magnetometer 403. In this way, the prediction of the orientation of the head-mounted display 101 for a particular moment in time is corrected by a measurement of motion from which the actual orientation at that moment in time can be inferred.

### FIG. 15

The viewpoint control process 1500 used by viewpoint controller 410 is detailed in FIG. 15. As described previously, viewpoint controller 410 has a dual function in the present embodiment of first being responsible for calculating adjustments to the orientation of the viewpoint in rendering processor 412, along with adjusting the field of view in rendering processor 412 in response to changes made to the field of view control 411.

Thus following receipt of a prediction of the next orientation of the head-mounted display 101 at step 1501, the orientation of the viewpoint in rendering processor 412 is adjusted accordingly at step 1502. In an embodiment, this is achieved by generating an appropriate rotation quaternion to effect the change to a vector describing the existing orientation of the viewpoint in the rendering processor 412.

Following this change to the orientation of the viewpoint, a question is asked at step 1503 as to whether any change to the field of view of the viewpoint has been received from the field of view control 411. If this answer is answered in the affirmative, then at step 1504 the viewpoint field of view is adjusted accordingly. This may in an embodiment involve a small change on each iteration of the viewpoint control process so as to ensure a smooth transition in field of view. Control then returns to step 1501, which is also the case if the question asked at step 1503 is answered in the negative.

By predicting the orientation of the head-mounted display 101, it is possible to anticipate the angular motion and to determine the orientation of the viewpoint from which the left and right images should be rendered. By operating this process at a rate of, in the present embodiment, 600 hertz, the effects of motion sickness caused by latency between changes in head orientation and corresponding visual feedback are minimized.

### FIG. 16

The rendering process 1600 used by rendering processor 412 to generate one of the left or right images for output is detailed in FIG. 16. The process is performed twice, once for the left image and once for the right image, within the render refresh interval. Generation of the images can be carried out at the same time or sequentially, depending upon the implementation of the rendering processor 412 in the FPGA 305.

As is normal in a rendering process, the viewing frustum is first calculated at step 1601 based upon the direction of the viewpoint in the renderer, and the field of view. The viewing frustum is then used to enable a texture mapping process to be performed at step 1602. The process of texture mapping will be described with reference to FIGS. 17 and 18.

Following the texture mapping process, the completed render is outputted to the appropriate display 202 or 203 via display interface 306.

In the present embodiment, the rendering process is designed to operate as a pipeline, such that once each step is performed for one image, that same step may be performed for the next image immediately. In this way, the high refresh rate of 600 hertz can be maintained.

### FIG. 17

The rendering procedure used in the present embodiment is much akin to the use of sky mapping to create backgrounds in many three-dimensional video games. The overall process involves surrounding the viewpoint with a sphere (a skydome) or polyhedron, such as a cube (a skybox), and projecting onto the inner surface of the sphere or polyhedron a pre-rendered texture by texture mapping. Thus, in the present embodiment, for each left and right image, a sphere or polyhedron is rendered as the only object in the scene, with the appropriate pre-rendered texture being mapped thereon.

Referring now to FIG. 17, a graphical representation of the texture mapping process of step 1602 is shown. The three-dimensional object to be rendered is in the present embodiment, substantially a sphere 1701, which is composed of a large number of triangles as is preferred practice. Alternatively, the object to be rendered could be any other polyhedron, such as a cube.

A viewing frustum 1702 is shown inside sphere 1701, which allows a process of clipping and rasterization to be performed by rendering processor 412 at step 1711. This results in the generation of a set of fragments 1703, which may then be shaded by a shader routine in rendering processor 412 at step 1712 to produce a set of shaded fragments 1704. This allows pre-emptive correction of any distortions in stereoscopic display 201, such as chromatic aberration for example. It is also contemplated that vertex shaders could be used prior to rasterization to correct for geometric distortions, such as barrel distortion for example. The texture in texture buffer 409 is then accessed. In one embodiment, the textures are fully panoramic equirectangular textures 503, which are an equirectangular projection of 360 degree pre-rendered scenes in the virtual environment. Alternatively, the textures can be icosahedral textures 504, which are icosahedral projections of 360 degree pre-rendered scenes in the virtual environment. The icosahedral projection avoids the distortion at the poles associated with equirectangular projections, and uses around 40 percent less storage. Should a cube be used as the object to be rendered, for example, rather than a sphere, then a cube map type texture could be used, the appearance of which will be familiar to those skilled in the art. Should it be determined that insufficient bandwidth is available to transfer the fully panoramic textures to the image generation device 301, then only the required portion of the textures for the prediction of the required field of view over the texture update interval will be in the texture buffer 409. In this case, these smaller textures are still accessed and mapped onto the appropriate viewable part of the sphere 1701 (or polyhedron) in the viewing frustum 1702.

Following shading, the appropriate texture 1705 or 1706 may be mapped on to the fragments by a texture mapping at step 1713, which involves a process of sampling and filtering the texture to be applied, which will be familiar to those skilled in the art, and results in the generation of a final rendered image 1707 for display.

This overall process is performed for both of the left and the right images, thereby generating a sequence of stereoscopic imagery for head-mounted display 101 depicting a virtual environment.

### FIG. 18

A formal detailing of the procedure carried out during texture mapping step 1602 is shown in FIG. 18.

At step 1711, clipping and rasterization is performed on the object to be rendered, based upon the viewing frustum calculated in step 1601. This results in the generation of set of fragments, which are subjected to shading at step 1712. Finally, the appropriate texture is sampled, filtered and applied to the set of fragments to create a rendered image in step 1713.

### FIG. 19

As described previously with reference to FIG. 2, texture server 206 may take the form of either a texture storage device, which includes high-speed storage for pre-rendered textures, or a texture generation device, which includes processing capability for pre-rendering textures.

The first of these embodiments of texture server 206 is shown diagrammatically in FIG. 19, in which it is configured as a texture storage device 1901 responsive to requests from texture fetching processor 406.

Texture storage device 1901 in this embodiment includes a data interface 1902 for network I/O tasks, which is configured to receive requests issued by texture fetching processor 406 in image generation device 301. Data interface 1902 is configured to operate according to the same protocol as data interface 304, which in the present embodiment is 802.11ac.

Internal communication within the texture storage device 1901 is facilitated by the provision of a high-speed internal bus 1903, attached to which is a processing device, which in this case is a central processing unit (CPU) 1904, and memory, which in this case is provided by a system solid state disk (SSD) 1905, and random access memory (RAM) 1906. During operation, operating system instructions and texture retrieval instructions are loaded from SSD 1905 into RAM 1906 for execution by CPU 1904. The CPU 1904 in the present embodiment is a quad-core processing unit operating at 3 gigahertz, the SSD 1905 is a 512 gigabyte PCI Express® solid state drive, and the RAM 1906 is DDR3 totaling 16 gigabytes in capacity.

The storage device for the textures in the present embodiment is an SSD 1907 which is of the same specification as SSD 1905. In the current implementation, the left pre-rendered textures and the right pre-rendered textures are stored by the SSD 1907 in compressed form. In one embodiment they are stored with spatial compression such as JPEG, and in another embodiment temporal compression. The compression types could also be combined, using MPEG techniques for example. Should disk read speed become an issue in texture server 206, an additional SSD could be provided such that the left pre-rendered textures are stored on one SSD, and the right pre-rendered textures are stored on another SSD. In this way, read operations by the disks could be performed in parallel.

### FIG. 20

A diagrammatic representation of the ways in which textures may be retrieved from texture storage device 1901 is shown in FIG. 20.

One exemplary, fully panoramic texture 2001 is shown in the Figure, which is stored on SSD 1907. In the present case, the texture 2001 has been pre-rendered and is a texture suitable for reproduction of one of a stereoscopic pair of images at one position along path 105. If sufficient bandwidth is available, then the whole of the texture 2001 can be retrieved by texture fetching processor 406 to subsequently refresh the texture buffer 409. However, if insufficient bandwidth is available for transmission of the whole of texture 2001, then as described previously, only a required portion need be sent.

Thus in one embodiment of the present invention, the fully panoramic texture 2001 is considered to be composed of a plurality of tiles, such as tile 2002. Texture fetching processor 406 is in this case additionally configured to take into account the current orientation of the head-mounted display 101 using the output of the motion sensors 302. Using the current orientation, and information pertaining to the current motion of the head-mounted display 101, an assessment can be made as to the extent of the field of view required for the production of stereoscopic imagery over the texture refresh interval. As shown in the Figure, a current field of view 2003 at the start of the texture refresh interval is shown along with a predicted field of view 2004, representing the predicted field of view at the end of the texture refresh interval. The fields of view extend over a set of required tiles 2005 making up a portion of the texture 2001 stored on SSD 1907.

The method of selecting the tiles in the present embodiment includes a process of considering the locations of the tiles of the texture 2001 as lying on the surface of sphere 1701, and ray tracing around the edge of each tile from the render viewpoint to identifying if any pixel on the edge of a tile coincides with the predicted extent of the field of view over the texture refresh interval. Alternative search algorithms could of course be used to identify the required tiles. The size of the tiles into which the textures are divided is determined by seeking a balance between a high enough resolution to minimize the totality of data transmitted from the texture storage device 1901 to the image generation device 301 (which encourages division into more tiles), and a high enough processing efficiency for the identification of required tiles (which encourages division into fewer tiles).

Following identification, the texture buffer 409 is refreshed with the required tiles 2005 which may then be used by rendering processor 412.

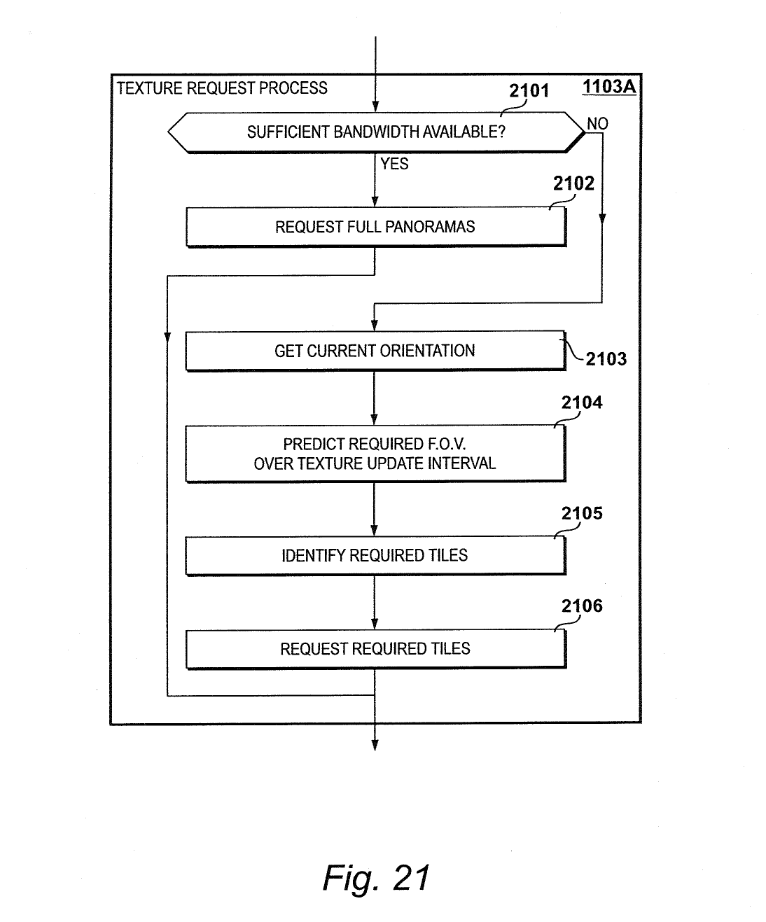

### FIG. 21

The texture request process carried out during step 1103 when head-mounted display 101 is in communication with texture storage device 1901, is detailed in FIG. 21, in which the procedures are generally identified as step 1103A.

Following step 1102, step 1103A is entered, at which point a question is asked at step 2101 as to whether sufficient bandwidth is available for the totalities of the required texture pair to be retrieved from the texture storage device 1901. If this question is answered in the affirmative, then the fully panoramic texture pair is requested at step 2102.

However, if the question asked at step 2101 is answered in the negative, to the effect that it is determined that sufficient bandwidth is not available, then control proceeds to step 2103 where the current orientation of the image generation device 301 is found. At step 2104, a prediction is made as to the total required field of view over the texture update interval. In the present embodiment, this step may involve the use of a Kalman filter to enable a prediction to be made. A constant angular velocity model can then be employed. Following the assessment as to the extent of the required field of view, the tiles required to satisfy the predicted change in field of view over the texture update interval are identified at step 2105. As described previously, in the present embodiment, this step involves performing a ray tracing search to find tiles falling within the predicted field of view.

Following identification, the required tiles are requested from the texture storage device 1901 at step 2106.

### FIG. 22

The texture retrieval process 2200 executed by CPU 1904 to satisfy the request made at step 1103A is detailed in FIG. 22.

At step 2201, a request for a particular pair of textures is received via data interface 1902 from the image generation device 301. This step may in a possible embodiment involve performing a rounding operation to convert the request from the texture fetching processor 406 which specifies the predicted position of the head-mounted display 101, into a request for a specific pair of left and right textures from the first SSD 1907.

Following receipt of the request, a question is asked at step 2202 as to the nature of the request, i.e. is the request for fully panoramic textures or for particular tiles forming part of the textures. If fully panoramic textures are requested, then they are retrieved from SSD 1907 at step 2203. If tiles are requested, then they are retrieved from SSD 1907 at step 2204.

Following successful read operations from the SSD 1907, in step 2205, the textures are sent in the appropriate form to image generation device 301 via data interface 1902 whereupon they can be used for rendering.

As described previously with reference to FIG. 11, the textures are transmitted in the present embodiment in compressed form, but alternatively may be decompressed by CPU 1904 prior to sending to image generation device 301 at step 2004 if sufficient bandwidth is available.

### FIG. 23

An alternative, second embodiment of texture server 206 is illustrated in FIG. 23 in which it is configured as a texture generation device 2301 responsive to requests from texture fetching processor 406.

Texture generation device 2301 in this second embodiment includes a data interface 2302 for network I/O tasks, which is configured to receive requests issued by texture fetching processor 406 in image generation device 301. Data interface 2302 is configured to operate according to the same protocol as data interface 304, which in the present embodiment is 802.11ac.

Internal communication within the texture generation device 2301 is facilitated by the provision of a high-speed internal bus 2303, attached to which is a processing device, which in this case is a central processing unit (CPU) 2304, and memory, which in this case is provided by random access memory (RAM) 2305 and a solid state disk (SSD) 2306, all of the same specification as those components in texture storage device 1901. RAM 2305 and SSD 2306 together provided memory for storing operating system instructions and rendering program instructions, along with scene data for the entirety of the virtual environment for which imagery is to be rendered for head-mounted display 101. The scene data includes models, lighting and textures etc. for the virtual environment.

In addition to CPU 2304, a pair of graphics processing units (GPUs) is provided: a first GPU 2307 and a second GPU 2308, which are also connected to the internal bus 2303 to facilitate the execution of real-time rendering of left and right textures respectively from the scene data in RAM 2305.

### FIG. 24

A diagrammatic representation of the ways in which textures may be retrieved from texture generation device 2301 is shown in FIG. 24.

In this embodiment, texture generation device 2301 may render a fully panoramic texture 2401, suitable for reproduction of one of a stereoscopic pair of images at one position depicting a scene along path 105, or instead may only render a portion texture 2402 depicting the scene along path 105. In a similar way to the required tiles 2005, the texture 2402 is generated such that it sufficiently covers the predicted change to the orientation of the head-mounted display 101 over the texture refresh interval. There is no need for tiles in this way of generating the textures, as it optimally efficient for the rendering program used by texture generation device 2301 to only render exactly the extent of the scene that is required.

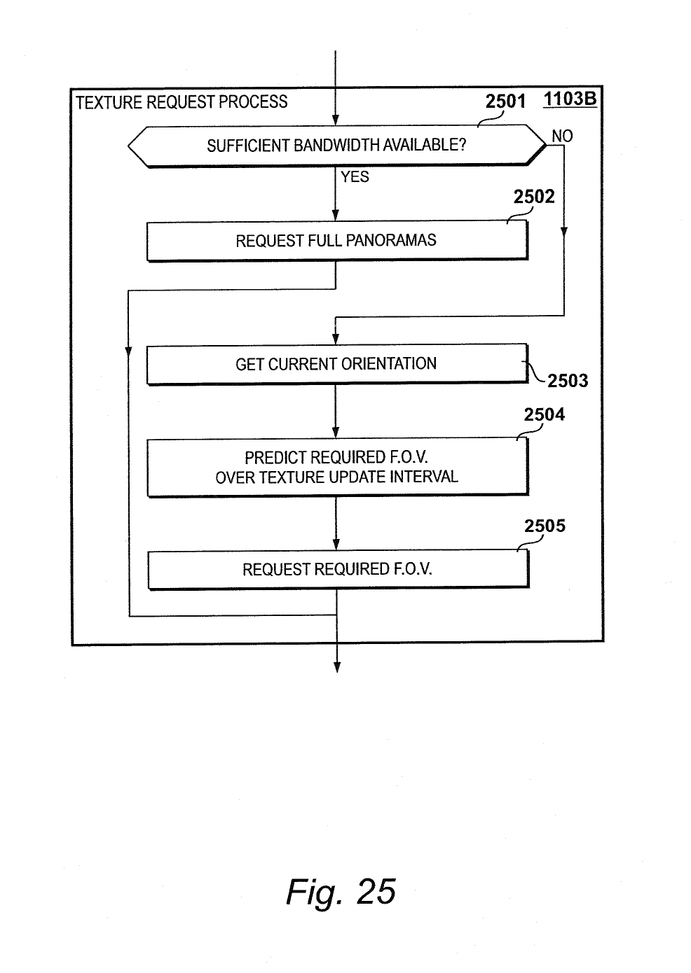

### FIG. 25

The texture request process carried out during step 1103 when head-mounted display 101 is in communication with texture generation device 2301, is detailed in FIG. 25 and identified as step 1103B, to differentiate it from step 1103A. Following rounding at step 1102, a question is asked at step 2501 as to whether sufficient bandwidth is available for the totalities of the required texture pair to be retrieved from the texture generation device 2301. If this question is answered in the affirmative, then the fully panoramic texture pair is requested at step 2502.

However, if the question asked at step 2501 is answered in the negative, to the effect that it is determined that sufficient bandwidth is not available, then control proceeds to step 2503 where the current orientation of the image generation device 301 is found. At step 2504, a prediction is made as to the total required field of view over the texture update interval. In the present embodiment, this step may involve the use of a Kalman filter to enable a prediction to be made. A constant angular velocity model can then be employed. Following the assessment as to the extent of the required field of view, this information is conveyed to the texture storage device 2301 in the form of a request at step 2505.

### FIG. 26

The texture generation process 2600 executed by CPU 2304 is detailed in FIG. 26.

A request for textures is received at step 2601 from texture fetching processor 406 via data interface 2302. As described previously with reference to FIG. 11, texture fetching processor 406 may send a request in the form of a raw output of the predicted position of the head-mounted display 101. This allows in this embodiment the texture generation process 2600 to generate a pair of left and right pre-rendered textures for image generation device 301 in which the render viewpoint thereof corresponds exactly to the predicted position.

At step 2602, a question is asked as to whether the request takes the form of a request for a pair of fully panoramic textures, or only for portions corresponding to the predicted extent of the field of view over the texture refresh interval.

If a full panorama has been requested, the rendering of the full panoramas takes place at step 2603, or alternatively if only portions are required then they are rendered at step 2604. By making reference to the scene data stored in RAM 2305 and by making appropriate use of first GPU 2307 and second GPU 2308 respectively, the left right textures are rendered from the predicted position of the head-mounted display 101. The rendering procedure can be any form of rendering process which can produce images of the scene from left and right viewpoints, and may possibly use a game engine to facilitate efficient generation of the textures. As described previously with reference to FIG. 17, the pre-rendered textures can be either equirectangular projections of a scene, or icosahedral projections of the same, and will either be fully panoramic, 360 by 180 degree renders, or will be portions thereof generated by taking into account the predicted extent of the field of view over the texture refresh interval.

The textures are then sent at step 2605 to image generation device 301 via data interface 2302 whereupon they can be used for rendering for the head-mounted display 101. Again, the textures can be transmitted in compressed or uncompressed form. Should they be transmitted in compressed form, then CPU 2304 can perform JPEG compression, for example, prior to transmission via the data interface 2302.

What we claim is:

1. Apparatus for generating a sequence of stereoscopic images for a head-mounted display depicting a virtual environment, comprising:
an angular motion sensor configured to output an indication of an orientation of the head-mounted display;
a texture buffer that is refreshed with a left and a right texture respectively defining a left and a right pre-rendered version of one of a plurality of possible scenes in said virtual environment;
a rendering processor configured to render left and right images from respective render viewpoints, including a process of mapping the left texture onto one of a left sphere and polyhedron, and mapping the right texture onto one of a right sphere and polyhedron, and wherein a direction of the render viewpoints is determined by an output of the angular motion sensor; and
a display interface for outputting the left and right images to a stereoscopic display in the head-mounted display;
wherein the rendering processor renders the left and right images at a higher rate than the left and right textures are refreshed in the texture buffer.

2. The apparatus of claim 1, in which the left and right textures are one of equirectangular and icosahedral projections of the left and right pre-rendered scenes.

3. The apparatus of claim 1, further comprising a data interface for communication with a texture storage device which stores a plurality of left and right textures, each of which respectively defines a left and a right pre-rendered version of each one of a plurality of scenes in said virtual environment.

4. The apparatus of claim 3, in which the plurality of scenes together depict progression along a path in said virtual environment.

5. The apparatus of claim 1, in which the left and right textures are received in a spatially compressed format.

6. The apparatus of claim 1, in which the left and right textures are received in a temporally compressed format.

7. The apparatus of claim 6, further comprising a decoder to decode the compressed left and right textures, which are subsequently stored in the texture buffer in uncompressed form.

8. The apparatus of claim 1, further comprising an orientation estimation processor configured to predict an orientation of the apparatus to determine the render viewpoints.

9. The apparatus of claim 8, in which the orientation of the apparatus is predicted using a Kalman filter by carrying out a predict step using a dynamical model, followed by an update step using an output of the angular motion sensor.

10. The apparatus of claim 1, further comprising a linear motion sensor configured to provide an output indicative of linear motion of the apparatus.

11. The apparatus of claim 10, further comprising a position estimation processor configured to predict a position of the apparatus to determine which left and right textures to load into the texture buffer.

12. The apparatus of claim 11, in which the position of the apparatus is predicted using a Kalman filter by carrying out a predict step using a dynamical model, followed by an update step using the output of the linear motion sensor.

13. The apparatus of claim 1, in which the texture buffer is updated at 60 hertz.

14. The apparatus of claim 1, in which the rendering processor renders the left and right images at 600 hertz.

15. The apparatus of claim 1, in which the rendering processor is configured to output the left and right images directly to said stereoscopic display via the display interface without writing to a frame buffer.

16. A method of generating a sequence of stereoscopic imagery for a head-mounted display, the imagery depicting progression along a path through a virtual environment when moving along said path in a real environment, comprising the steps of:
at a first refresh rate, loading into memory a left texture and a right texture defining respective pre-rendered versions of a scene in said virtual environment, the textures corresponding to a predicted position of the head-mounted display on said path;
at a second refresh rate, displaying rendering of left and right images rendered from respective render viewpoints, in which the left and right textures in memory are mapped onto one of respective spheres and polyhedrons, and wherein the render viewpoints are based on a predicted orientation of the head-mounted display; and
at the second refresh rate, displaying the left and right images in a head-mounted display;
wherein the first refresh rate is lower than the second refresh rate.

17. The method of claim 16, in which a predicted location is derived by comparing an output of a linear motion sensor in the head-mounted display to a dynamical model.

18. The method of claim 16, in which the predicted orientation is derived by comparing an output of an angular motion sensor in the head-mounted display to a dynamical model.

19. The method of claim 16, in which the path in said real environment is a path taken by a passenger on an amusement ride.

20. A head-mounted display for displaying a sequence of stereoscopic imagery depicting progression along a path through a virtual environment when moving along said path in a real environment, comprising:
a linear motion sensor configured to provide an output indicative of a position of the head-mounted display;
a data interface configured to retrieve, from one of a remote texture storage and a generation device, a left and a right texture respectively defining a left and a right pre-rendered version of a scene in said virtual environment corresponding to the position of the head-mounted display;
a texture buffer configured to store the left and right textures;
an angular motion sensor configured to provide an output indicative of an orientation of the head-mounted display;
a rendering processor configured to render left and right images from respective render viewpoints, including mapping the left texture onto one of a left sphere and left polyhedron, and mapping the right texture onto one of a right sphere and right polyhedron, and wherein a direction of the render viewpoints is determined by the orientation of the head-mounted display; and
a stereoscopic display configured to display the left and right images;
wherein the rendering processor renders the left and right images at a higher rate than the left and right textures are refreshed in the texture buffer.
